(19) United States
(12) Patent Application Publication
(10) Pub. No.: US 2026/0025780 A1
(43) Pub. Date: Jan. 22, 2026

(54) AI/ML-BASED DEVICE POSITIONING WITH SIGNALING AND INDICATION OF ADDITIONAL PATH MEASUREMENT PURPOSE

(71) Applicant: QUALCOMM Incorporated, San Diego, CA (US)

(72) Inventors: Mohammed Ali Mohammed Hirzallah, San Marcos, CA (US); Taesang Yoo, San Diego, CA (US); Jay Kumar Sundararajan, San Diego, CA (US)

(21) Appl. No.: 18/774,355

(22) Filed: Jul. 16, 2024

(51) Int. Cl. H04W 64/00; H04W 8/22; H04W 24/02; H04W 24/10

(52) U.S. Cl. CPC H04W 64/00; H04W 8/22; H04W 24/02; H04W 24/10

(57) ABSTRACT

A network entity is configured to receive, from a network node, first path measurement information for a first path, receive, from the network node, additional path measurement information for one or more additional paths, receive, from the network node, an indication of a purpose of the additional path measurement information, and determine a location of the network node based on the first path measurement information, the additional path measurement information, and the purpose of the additional path measurement information.

### TECHNICAL FIELD

This disclosure relates to systems for device positioning.

### BACKGROUND

It may be important for some types of devices to be able to determine their physical positions. For example, it is frequently useful for smartphones or wearable devices to be able to accurately determine their current physical locations. Conventional positioning techniques, such as the Global Positioning System (GPS), are typically unable to provide a sufficient level of positional accuracy, especially when the devices are located inside buildings or within complex environments, such as dense urban areas. Triangulation based on direct signal strengths of wireless signals may also be used for determining positions of devices, but the accuracy may be diminished because the wireless signals may follow multiple paths.

### SUMMARY

User equipment (UE), base stations (e.g., gNBs), and/or location servers (e.g., executing a location management function (LMF)) may be configured to determine the location of a UE based on measurements of reference signals. In some scenarios, such as non line-of-sight (NLOS) communications, machine learning (ML) models have shown to be effective at helping determine the location of a UE. ML models may be trained to generate output data, such as location data or intermediate data used as input to a secondary positioning process that generates the location data.

In some examples, a network node, such as a UE or base station, may be configured to generate path measurement information for a first communication path between a UE and a transmission-reception point (TRP). The path measurement information may include timing information, power information, phase information, angle information, and/or LOS information. The network node may send the path measurement information to an LMF to determine a location of the UE. In some examples, a network node may be configured to generate first path measurement information as well as additional path measurement information. In some examples, an LMF may use the additional path measurement information to determine particular techniques to use to determine the location of the UE. However, the additional path measurement information may be ambiguous, and as such, the usefulness of the additional path measurement information may be limited.

This disclosure describes techniques that address this issue. As described herein, a network node, such as a UE or base station, may be configured to send first path measurement information for a first path as well as additional path measurement information. The network node may be further configured to send an indication of a purpose of the additional path measurement information to an LMF. The purpose of the additional path measurement information may be two or more of a legacy purpose, a second physical path (e.g., different from the first path), and/or a multi-hypotheses distribution of the first path. The first path may be a line-of-sight (LOS) direct path or a non-LOS (NLOS) path. By knowing the purpose of the additional path measurement, the LMF may determine a particular technique that utilizes the additional path measurement information to determine a location of the UE. As such, the LMF may more accurately determine the location of a UE when using additional path measurement information.

In one example, this disclosure describes a network node configured for wireless communication, the network node comprising a memory, and one or more processors implemented in circuitry. The one or more processors are communicatively coupled to the memory, and wherein the one or more processors are configured to cause the network node to send, to a network entity, first path measurement information for a first path, send, to the network entity, additional path measurement information for one or more additional paths, and send, to the network entity, an indication of a purpose of the additional path measurement information, wherein one or more of the first path measurement information or the additional path measurement information is used by the network entity to determine a location of the network node.

In another example, this disclosure describes a method performed by a network node for wireless communication, the method comprising sending, to a network entity, first path measurement information for a first path, sending, to the network entity, additional path measurement information for one or more additional paths, and sending, to the network entity, an indication of a purpose of the additional path measurement information, wherein one or more of the first path measurement information or the additional path measurement information is used by the network entity to determine a location of the network node.

In another example, this disclosure describes a network node configured for wireless communication, the network node comprising means for sending, to a network entity, first path measurement information for a first path, means for sending, to the network entity, additional path measurement information for one or more additional paths, and means for sending, to the network entity, an indication of a purpose of the additional path measurement information, wherein one or more of the first path measurement information or the additional path measurement information is used by the network entity to determine a location of the network node.

In another example, this disclosure describes a non-transitory computer-readable storage medium storing instructions that, when executed, cause one or more processors of a network node to send, to a network entity, first path measurement information for a first path, send, to the network entity, additional path measurement information for one or more additional paths, and send, to the network entity, an indication of a purpose of the additional path measurement information, wherein one or more of the first path measurement information or the additional path measurement information is used by the network entity to determine a location of the network node.

In another example, this disclosure describes a network entity configured for wireless communication, the network entity comprising a memory, and one or more processors implemented in circuitry, wherein the one or more processors are communicatively coupled to the memory. The one or more processors are configured to cause the network entity to receive, from a network node, first path measurement information for a first path, receive, from the network node, additional path measurement information for one or more additional paths, receive, from the network node, an indication of a purpose of the additional path measurement information, and determine a location of the network node based on the first path measurement information, the additional path measurement information, and the purpose of the additional path measurement information.

In another example, this disclosure describes a method performed by a network entity configured for wireless communication, the method comprising receiving, from a network node, first path measurement information for a first path, receiving, from the network node, additional path measurement information for one or more additional paths, receiving, from the network node, an indication of a purpose of the additional path measurement information, and determining a location of the network node based on the first path measurement information, the additional path measurement information, and the purpose of the additional path measurement information.

In another example, this disclosure describes a network entity configured for wireless communication, the network entity comprising means for receiving, from a network node, first path measurement information for a first path, means for receiving, from the network node, additional path measurement information for one or more additional paths, means for receiving, from the network node, an indication of a purpose of the additional path measurement information, and means for determining a location of the network node based on the first path measurement information, the additional path measurement information, and the purpose of the additional path measurement information.

In another example, this disclosure describes a non-transitory computer-readable storage medium storing instructions that, when executed, cause one or more processors of a network entity to receive, from a network node, first path measurement information for a first path, receive, from the network node, additional path measurement information for one or more additional paths, receive, from the network node, an indication of a purpose of the additional path measurement information, and determine a location of the network node based on the first path measurement information, the additional path measurement information, and the purpose of the additional path measurement information.

The details of one or more examples are set forth in the accompanying drawings and the description below. Other features, objects, and advantages will be apparent from the description, drawings, and claims.

### BRIEF DESCRIPTION OF DRAWINGS

FIG. 1 illustrates an example wireless communications system, according to aspects of the disclosure.

FIG. 2A illustrates an example wireless network structure.

FIG. 2B illustrates another example wireless network structure.

FIG. 2C illustrates an example disaggregated base station architecture, according to aspects of the disclosure.

FIG. 3A illustrates possible locations of a quasi-model relation (QML) component.

FIG. 3B illustrates possible locations of a QML component.

FIG. 3C illustrates possible locations of a QML component.

FIG. 4 is a diagram illustrating an example frame structure.

FIG. 5A is a diagram of an example slot structure without feedback resources, according to aspects of the disclosure.

FIG. 5B is a diagram of an example slot structure with feedback resources, according to aspects of the disclosure.

FIG. 6A is a diagram illustrating an example of a resource pool for positioning configured within a sidelink resource pool for communication (i.e., a shared resource pool), according to aspects of the disclosure.

FIGS. 6B and 6C are diagrams illustrating additional examples of resource pools for positioning configured within sidelink resource pools for communication.

FIG. 6D is a diagram illustrating another example of a resource pool for positioning configured within a sidelink resource pool for communication.

FIG. 7 illustrates examples of various positioning methods, according to aspects of the disclosure.

FIG. 8A illustrates various scenarios of interest for sidelink-only or joint Uu and sidelink positioning.

FIG. 8B illustrates additional scenarios of interest for sidelink-only or joint Uu and sidelink positioning.

FIG. 9 illustrates an example neural network, according to aspects of the disclosure.

FIG. 10 is an illustrative block diagram of an example ML architecture that may be used for wireless communications in any of the various implementations, processes, environments, networks, or other use cases.

FIG. 11 is an illustrative block diagram of an example ML architecture of a first wireless device in communication with a second wireless device.

FIG. 12A, FIG. 12B, and FIG. 12C are block diagrams illustrating example styles of implementing AI/ML-assisted positioning systems.

FIG. 13A is a block diagram illustrating an example of a direct positioning system in accordance with one or more techniques of this disclosure.

FIG. 13B is a block diagram illustrating an example of an indirect positioning system in accordance with one or more techniques of this disclosure.

FIG. 14A is a block diagram illustrating a first example system in accordance with one or more techniques of this disclosure.

FIG. 14B is a block diagram illustrating a second example system in accordance with one or more techniques of this disclosure.

FIG. 14C is a block diagram illustrating a third example system in accordance with one or more techniques of this disclosure.

FIG. 14D is a block diagram illustrating a fourth example system in accordance with one or more techniques of this disclosure.

FIG. 14E is a block diagram illustrating a fifth example system in accordance with one or more techniques of this disclosure.

FIG. 15 is a conceptual diagram illustrating an NLOS path between a UE and a TRP.

FIG. 16 is a conceptual diagram illustrating positioning with three TRPs.

FIG. 17 is a block diagram illustrating examples of determining additional path measurements in accordance with one or more techniques of this disclosure.

FIG. 18 is a flowchart illustrating an example operation of a network node in accordance with one or more techniques of this disclosure.

FIG. 19 is a flowchart illustrating an example operation of a network entity in accordance with one or more techniques of this disclosure.

FIGS. 20A-20C are communication diagrams illustrating examples of indicating a purpose of the additional path measurement between a UE and an LMF in accordance with one or more techniques of this disclosure.

FIGS. 21A-21C are communication diagrams illustrating examples of indicating a purpose of the additional path measurement between a base station and an LMF in accordance with one or more techniques of this disclosure.

### DETAILED DESCRIPTION

User equipment (UE), base stations (e.g., gNBs), and/or location servers (e.g., executing a location management function (LMF)) may be configured to determine the location of a UE based on measurements of reference signals. In some scenarios, such as non line-of-sight (NLOS) communications, machine learning (ML) models have shown to be effective at helping determine the location of a UE. ML models may be trained to generate output data, such as location data or intermediate data used as input to a secondary positioning process that generates the location data.

In some examples, a network node, such as a UE or base station, may be configured to generate path measurement information for a first communication path between a UE and a transmission-reception point (TRP). The path measurement information may include timing information, power information, phase information, angle information, and/or LOS information. The network node may send the path measurement information to an LMF to determine a location of the UE. In some examples, a network node may be configured to generate first path measurement information as well as additional path measurement information. In some examples, an LMF may use the additional path measurement information to determine particular techniques to use to determine the location of the UE. However, the additional path measurement information may be ambiguous, and as such, the usefulness of the additional path measurement information may be limited.

This disclosure describes techniques that address this issue. As described herein, a network node, such as a UE or base station, may be configured to send first path measurement information for a first path as well as additional path measurement information. The network node may be further configured to send an indication of a purpose of the additional path measurement information to an LMF. The purpose of the additional path measurement information may be two or more of a legacy purpose, a second physical path (e.g., different from the first path), and/or a multi-hypotheses distribution of the first path. The first path may be a line-of-sight (LOS) direct path or a non-LOS (NLOS) path. By knowing the purpose of the additional path measurement, the LMF may determine a particular technique that utilizes the additional path measurement information to determine a location of the UE. As such, the LMF may more accurately determine the location of a UE when using additional path measurement information.

In one example, this disclosure describes a network node (e.g., UE or base station) configured for wireless communication, the network node comprising a memory, and one or more processors implemented in circuitry. The one or more processors are communicatively coupled to the memory, and wherein the one or more processors are configured to cause the network node to send, to a network entity, first path measurement information for a first path, send, to the network entity, additional path measurement information for one or more additional paths, and send, to the network entity, an indication of a purpose of the additional path measurement information, wherein one or more of the first path measurement information or the additional path measurement information is used by the network entity to determine a location of the network node. In another example, this disclosure describes a network entity (e.g., an LMF) configured for wireless communication, the network entity comprising a memory, and one or more processors implemented in circuitry, wherein the one or more processors are communicatively coupled to the memory. The one or more processors are configured to cause the network entity to receive, from a network node, first path measurement information for a first path, receive, from the network node, additional path measurement information for one or more additional paths, receive, from the network node, an indication of a purpose of the additional path measurement information, and determine a location of the network node based on the first path measurement information, the additional path measurement information, and the purpose of the additional path measurement information.

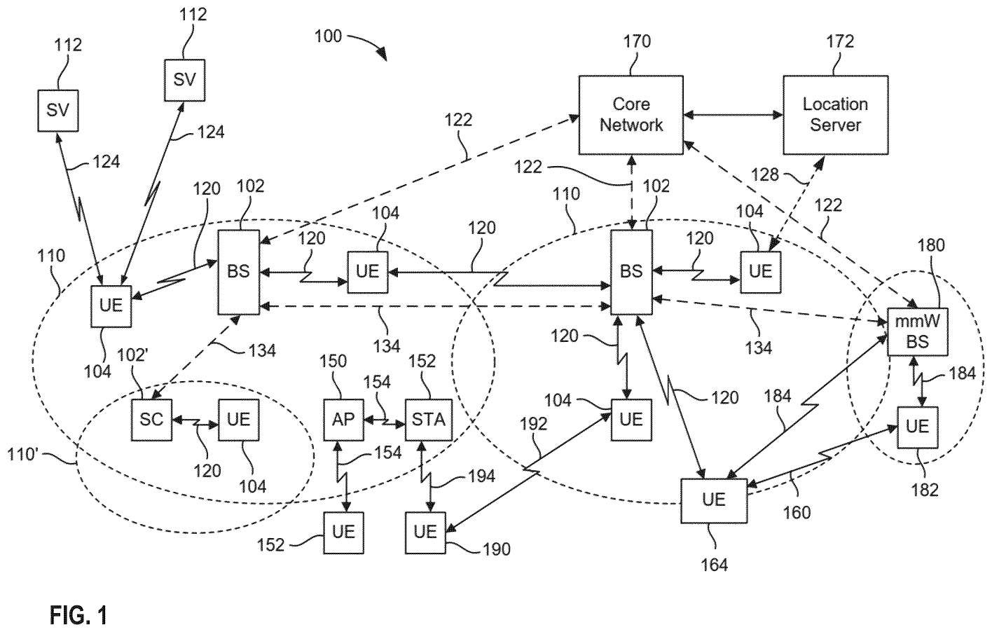

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to a Long Term Evolution (LTE) network, or gNBs where the wireless communications system 100 corresponds to a New Radio (NR) network, or a combination of both, and the small cell base stations may include femtocells, picocells, microcells, etc.

The base stations 102 may collectively form a radio access network (RAN) and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage arcas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use multiple-input multiple-output (MIMO) antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam. An SRS is a type of uplink reference signal used by the network to estimate the channel quality and propagation conditions. The SRS aids in beamforming, scheduling, and adaptive modulation, allowing the base station to optimize resource allocation and enhance communication performance.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” a “network entity,” a “network node,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as a network entity, an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

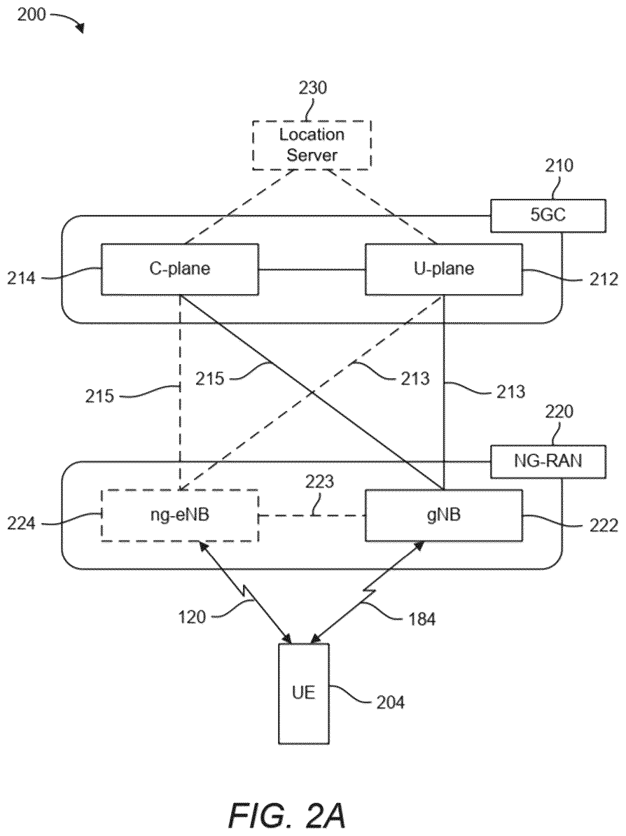

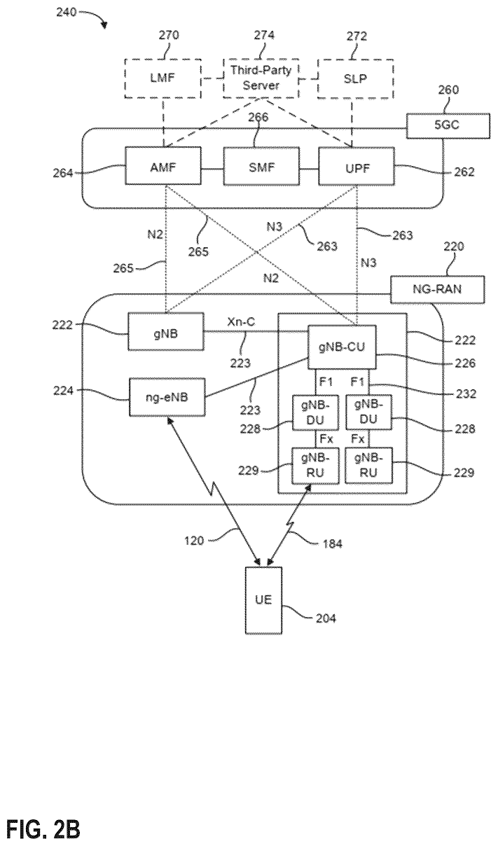

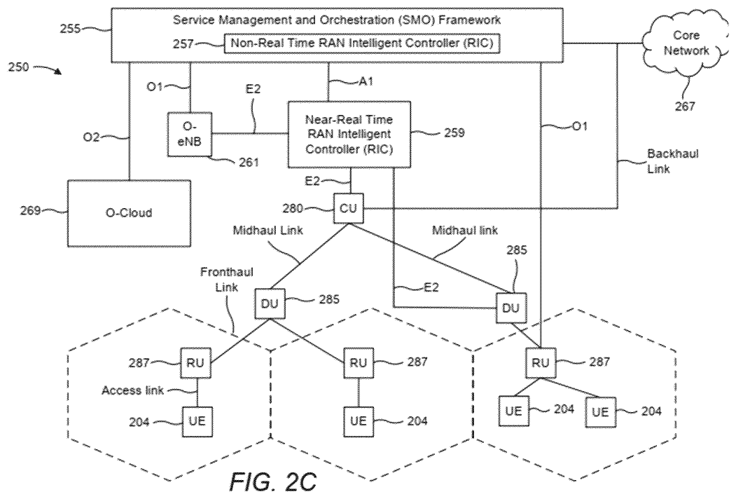

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

LMF 270 may be configured for managing and coordinating positioning and location-based services within a network (e.g., a 5G network). LMF 270 collects positioning measurements from various sources, processes this data to determine the precise location of user devices, and provides location information to applications and services that use such location information. LMF 270 may support multiple positioning techniques such as global navigation satellite system (GNSS), observed time difference of arrival (OTDOA), uplink time difference of arrival (UTDOA), as well as the AI/ML-based techniques of this disclosure, integrating data from these methods to enhance positioning accuracy and reliability. LMF 270 may work in conjunction with a base station (e.g., gNB) and other network components to deliver location services, which are useful for applications like emergency services, navigation, and Internet-of-Things (IoT).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network clements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

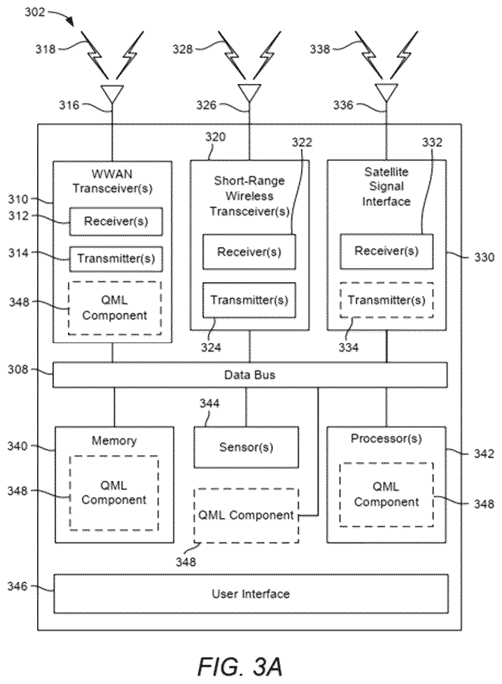

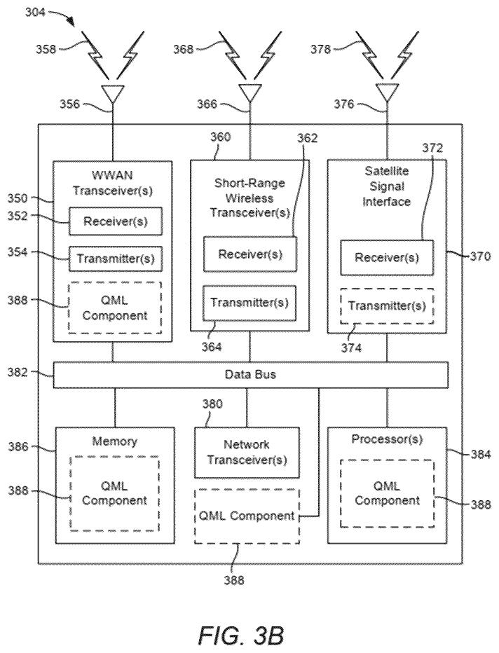

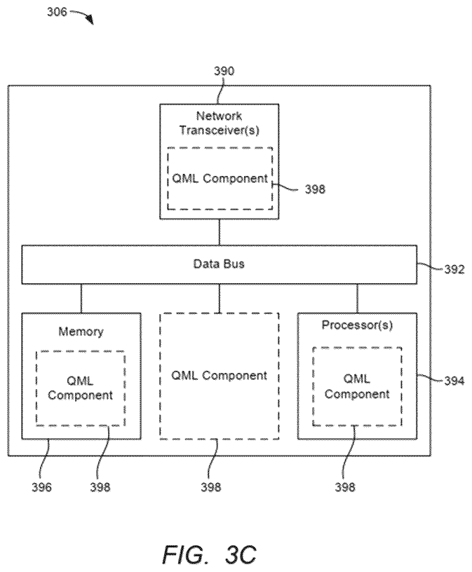

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include quasi-model relation (QML) component 348, 388, and 398, respectively. The QML component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the QML component 348, 388, and 398 may be external to the processors 342, 384, and 394 (e.g., part of a modem processing system, integrated with another processing system, etc.). Alternatively, the QML component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the QML component 348, which may be, for example, part of the one or more WWAN transceivers 310, the memory 340, the one or more processors 342, or any combination thereof, or may be a standalone component. FIG. 3B illustrates possible locations of the QML component 388, which may be, for example, part of the one or more WWAN transceivers 350, the memory 386, the one or more processors 384, or any combination thereof, or may be a standalone component. FIG. 3C illustrates possible locations of the QML component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may usc a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the QML component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

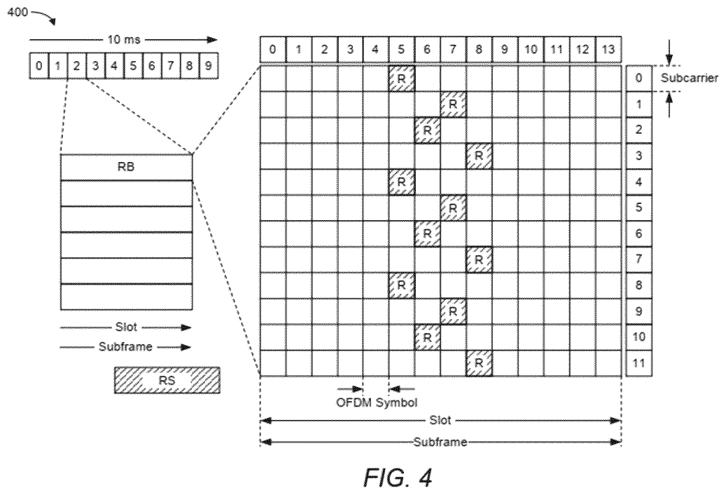

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource clements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre)configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

A collection of resource elements (REs) that are used for transmission of PRS is referred to as a “PRS resource.” A PRS is a downlink reference signal specifically designed for positioning purposes. A PRS enables the measurement of time differences and angles of arrival, facilitating accurate determination of the user device's location within the network. The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

In an aspect, the reference signal carried on the REs labeled “R” in FIG. 4 may be SRS. SRS transmitted by a UE may be used by a base station to obtain the channel state information (CSI) for the transmitting UE. CSI describes how an RF signal propagates from the UE to the base station and represents the combined effect of scattering, fading, and power decay with distance. The system uses the SRS for resource scheduling, link adaptation, massive MIMO, beam management, etc.

A collection of REs that are used for transmission of SRS is referred to as an “SRS resource,” and may be identified by the parameter “SRS-Resourceld.” The collection of resource elements can span multiple PRBs in the frequency domain and ‘N’ (e.g., one or more) consecutive symbol(s) within a slot in the time domain. In a given OFDM symbol, an SRS resource occupies one or more consecutive PRBs. An “SRS resource set” is a set of SRS resources used for the transmission of SRS signals, and is identified by an SRS resource set ID (“SRS-ResourceSetId”).

The transmission of SRS resources within a given PRB has a particular comb size (also referred to as the “comb density”). A comb size ‘N’ represents the subcarrier spacing (or frequency/tone spacing) within each symbol of an SRS resource configuration. Specifically, for a comb size ‘N,’ SRS are transmitted in every Nth subcarrier of a symbol of a PRB. For example, for comb-4, for each symbol of the SRS resource configuration, REs corresponding to every fourth subcarrier (such as subcarriers 0, 4, 8) are used to transmit SRS of the SRS resource. In the example of FIG. 4, the illustrated SRS is comb-4 over four symbols. That is, the locations of the shaded SRS REs indicate a comb-4 SRS resource configuration.

Currently, an SRS resource may span 1, 2, 4, 8, or 12 consecutive symbols within a slot with a comb size of comb-2, comb-4, or comb-8. The following are the frequency offsets from symbol to symbol for the SRS comb patterns that are currently supported. 1-symbol comb-2: {0}; 2-symbol comb-2: {0, 1}; 2-symbol comb-4: {0, 2}; 4-symbol comb-2: {0, 1, 0, 1}; 4-symbol comb-4: {0, 2, 1, 3} (as in the example of FIG. 4); 8-symbol comb-4: {0, 2, 1, 3, 0, 2, 1, 3}; 12-symbol comb-4: {0, 2, 1, 3, 0, 2, 1, 3, 0, 2, 1, 3}; 4-symbol comb-8: {0, 4, 2, 6}; 8-symbol comb-8: {0, 4, 2, 6, 1, 5, 3, 7}; and 12-symbol comb-8: {0, 4, 2, 6, 1, 5, 3, 7, 0, 4, 2, 6}.

Generally, as noted above, a UE transmits SRS to enable the receiving base station (either the serving base station or a neighboring base station) to measure the channel quality (i.e., CSI) between the UE and the base station. However, SRS can also be specifically configured as uplink positioning reference signals for uplink-based positioning procedures, such as uplink time difference of arrival (UL-TDOA), round-trip-time (RTT), uplink angle-of-arrival (UL-AoA), etc. As used herein, the term “SRS” may refer to SRS configured for channel quality measurements or SRS configured for positioning purposes. The former may be referred to herein as “SRS-for-communication” and/or the latter may be referred to as “SRS-for-positioning” or “positioning SRS” when needed to distinguish the two types of SRS.

Several enhancements over the previous definition of SRS may be available for SRS-for-positioning (also referred to as “UL-PRS”), such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a downlink reference signal or SSB from a neighboring TRP. Further still, one SRS resource may be transmitted outside the active BWP, and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There also may be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. These features may be configured through RRC higher layer signaling (and potentially triggered or activated through a MAC control element (MAC-CE) or downlink control information (DCI)).

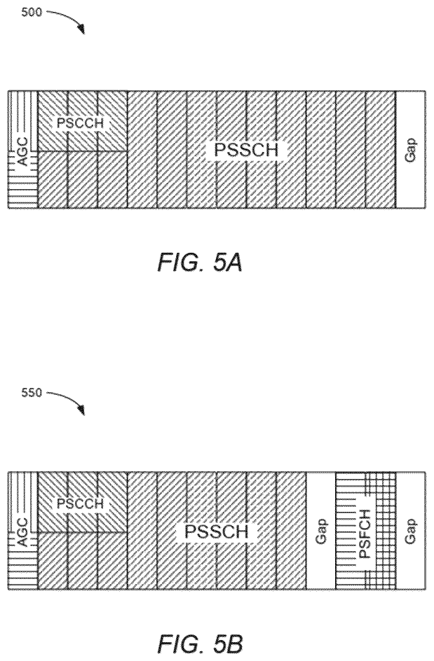

NR sidelinks support hybrid automatic repeat request (HARQ) retransmission. FIG. 5A is a diagram 500 of an example slot structure without feedback resources, according to aspects of the disclosure. In the example of FIG. 5A, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre)configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 5A by the vertical and horizontal hashing. As shown in FIG. 5A, for sidelink, the physical sidelink control channel (PSCCH) and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user data for the UE. In the example of FIG. 5A, the PSCCH occupies half the bandwidth of the sub-channel and only three symbols. Finally, a gap symbol is present after the PSSCH.

FIG. 5B is a diagram 550 of an example slot structure with feedback resources, according to aspects of the disclosure. In the example of FIG. 5B, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 5B is similar to the slot structure illustrated in FIG. 5A, except that the slot structure illustrated in FIG. 5B includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol after the PSSCH, there is a gap symbol after the two PSFCH symbols. Currently, resources for the PSFCH can be configured with a periodicity selected from the set of {0, 1, 2, 4} slots.

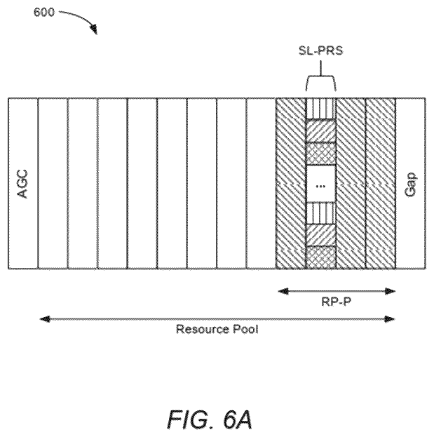

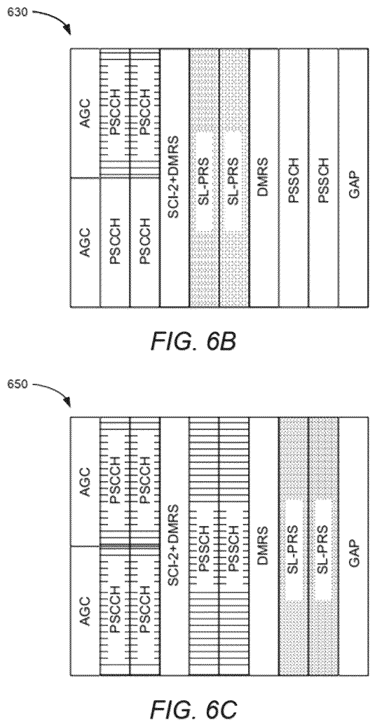

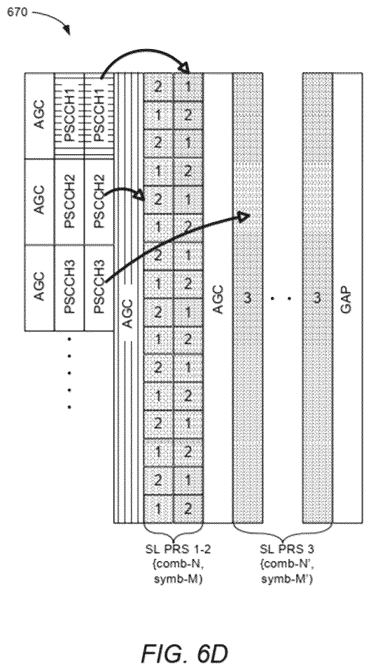

FIG. 6A is a diagram 600 illustrating an example of a resource pool for positioning configured within a sidelink resource pool for communication (i.e., a shared resource pool), according to aspects of the disclosure. In the example of FIG. 6A, time is represented horizontally and frequency is represented vertically. In the time domain, the length of each block is an orthogonal frequency division multiplexing (OFDM) symbol, and the 14 symbols make up a slot. In the frequency domain, the height of each block is a sub-channel.

In the example of FIG. 6A, the entire slot (except for the first and last symbols) can be a resource pool for sidelink communication. That is, any of the symbols other than the first and last can be allocated for sidelink communication. However, a resource pool for positioning (RP-P) is allocated in the last four pre-gap symbols of the slot. As such, non-sidelink positioning data, such as user data (PSSCH), channel state information reference signal (CSI-RS), and control information, can only be transmitted in the first eight post-automatic gain control (AGC) symbols and not in the last four pre-gap symbols to prevent a collision with the configured RP-P. The non-sidelink positioning data that would otherwise be transmitted in the last four pre-gap symbols can be punctured or muted, or the non-sidelink data that would normally span more than the eight post-AGC symbols can be rate matched to fit into the eight post-AGC symbols.

Sidelink positioning reference signals (SL-PRS) have been defined to enable sidelink positioning procedures among UEs. Like a downlink PRS (DL-PRS), a SL-PRS resource is composed of one or more resource elements (i.e., one OFDM symbol in the time domain and one subcarrier in the frequency domain). SL-PRS resources have been designed with a comb-based pattern to enable fast Fourier transform (FFT)-based processing at the receiver. SL-PRS resources are composed of unstaggered, or only partially staggered, resource elements in the frequency domain to provide small time of arrival (TOA) uncertainty and reduced overhead of each SL-PRS resource. SL-PRS may also be associated with specific RP-Ps (e.g., certain SL-PRS may be allocated in certain RP-Ps). SL-PRS have also been defined with intra-slot repetition (not shown in FIG. 6A) to allow for combining gains (if needed). There may also be inter-UE coordination of RP-Ps to provide for dynamic SL-PRS and data multiplexing while minimizing SL-PRS collisions.

FIGS. 6B and 6C are diagrams 630 and 650, respectively, illustrating additional examples of resource pools for positioning configured within sidelink resource pools for communication. Similar to FIG. 6A, the examples of FIGS. 6B and 6C illustrate shared resource pool structures. With respect to FIGS. 6B and 6C, in some designs, the following parameters may be defined, for example: physical sidelink control channel (PSCCH) and SL-PRS are only time-division multiplexed, PSSCH and SL-PRS are only time-division multiplexed (e.g., the maximum comb size is 4), PSSCH carries both type 2 sidelink control information (SCI-2) and a sidelink shared channel (SL-SCH) (e.g., a new SCI-2 format is introduced), SL-PRS is mapped on consecutive symbols, SL-PRS is not mapped on symbols with PSSCH demodulation reference signals (DMRS), and/or SL-PRS transmit power is the same as the transmit power of the PSSCH (e.g., this implies per-resource element power boosting will be applied for comb-2 and comb-4).

FIG. 6D is a diagram 670 illustrating another example of a resource pool for positioning configured within a sidelink resource pool for communication. In the example of FIG. 6D, a dedicated resource pool structure is depicted. With respect to FIG. 6D, in some designs, the following parameters may be defined, for example: SL-PRS is immediately preceded by an AGC symbol, SL-PRS is immediately followed by a gap symbol (at least when the gap symbol is the last sidelink symbol in a slot), PSCCH and SL-PRS can only be time-division multiplexed, different comb sizes (N) and SL-PRS durations (M) can be supported in the same resource pool (e.g., one set of SL-PRS resources can only have a single (M, N) combination), PSSCH is mapped to the first sidelink symbols in a slot, the number of PSCCH symbols is (pre-)configured to 1, 2, or 3, the number of physical resource blocks is (pre-)configured using sidelink communications values, and/or there is a one-to-one implicit mapping between PSCCH and SL-PRS.

In some designs, in a shared resource pool, with regards to the fields in SCI format 2-D, the following fields may be included, for example: a SL-PRS resource information indication of the current slot (ceiling(log2(#SL-PRS resources (pre-)configured in the resource pool) bits)), SL-PRS request (0 or 1 bit), and/or embedded SCI format ([X] bit(s)). If the “embedded SCI format” field is set to [0], the SCI 2-A fields are included with necessary padding. If the “embedded SCI format” field is set to [1], the SCI 2-B fields are included.

In some designs, for a shared resource pool, there may be an explicit (pre-)configuration of SL-PRS resources in a slot, applicable for an indicated frequency domain allocation, which includes, for example: SL-PRS Resource ID, (M, N) pattern, and/or comb offset. In some designs, for a given value of ‘M,’ a SL-PRS resource is mapped to the last consecutive ‘M’ sidelink symbol(s) in the slot that can be used for SL-PRS, taking into consideration multiplexing with PSSCH DMRS, phase tracking reference signals (PT-RS), CSI-RS, PSFCH, gap symbols, AGC symbols, and/or PSCCH in the slot. In some designs, the maximum number of SL-PRS resources in a slot of a shared resource pool may be (pre-)configured.

In some designs, in dedicated resource pools, with regards to the procedure for determining the subset of resources to be reported to higher layers, when triggering the resource (re-)selection procedure, the higher layers provide the following parameters for candidate SL-PRS transmission(s), for example: resource pool from which to report SL-PRS resources, priority, delay budget, reservation period, list of resources for pre-emption and re-evaluation, and/or the set of SL-PRS resource identifiers that can include all (pre-)configured SL-PRS resource identifiers.

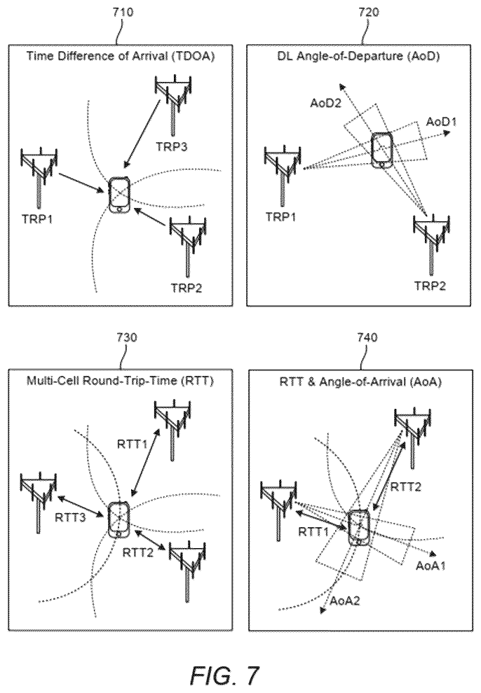

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 7 illustrates examples of various positioning methods, according to aspects of the disclosure. In an OTDOA or DL-TDOA positioning procedure, illustrated by scenario 710, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 720, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx−Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx−Tx) time difference. The Rx−Tx time difference measurement may be made, or may be adjusted, to include only a time difference between nearest slot boundaries for the received and transmitted signals. Both entities may then send their Rx−Tx time difference measurement to a location server (e.g., an LMF 270), which calculates the round trip propagation time (i.e., RTT) between the two entities from the two Rx−Tx time difference measurements (e.g., as the sum of the two Rx−Tx time difference measurements). Alternatively, one entity may send its Rx−Tx time difference measurement to the other entity, which then calculates the RTT. The distance between the two entities can be determined from the RTT and the known signal speed (e.g., the speed of light). For multi-RTT positioning, illustrated by scenario 730, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 740.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

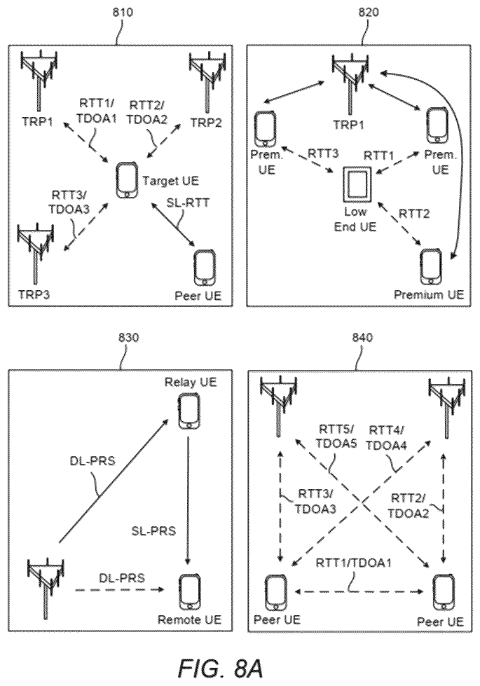

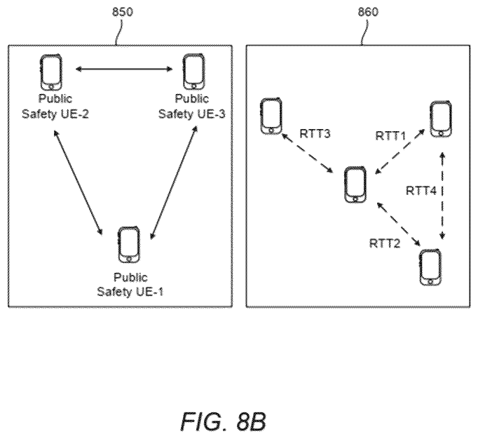

NR supports, or enables, various sidelink positioning techniques. FIG. 8A illustrates various scenarios of interest for sidelink-only or joint Uu and sidelink positioning, according to aspects of the disclosure. In scenario 810, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 820, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 830, a relay UE (e.g., with a known location) participates in the positioning estimation of a remote UE without performing uplink positioning reference signal (PRS) transmission over the Uu interface. Scenario 840 illustrates the joint positioning of multiple UEs. Specifically, in scenario 840, two UEs with unknown positions can be jointly located in non-line-of-sight (NLOS) conditions by utilizing constraints from nearby UEs.

FIG. 8B illustrates additional scenarios of interest for sidelink-only or joint Uu and sidelink positioning, according to aspects of the disclosure. In scenario 850, UEs used for public safety (e.g., by police, firefighters, and/or the like) may perform peer-to-peer (P2P) positioning and ranging for public safety and other uses. For example, in scenario 850, the public safety UEs may be out of coverage of a network and determine a location or a relative distance and a relative position among the public safety UEs using sidelink positioning techniques. Similarly, scenario 860 shows multiple UEs that are out of coverage and determine a location or a relative distance and a relative position using sidelink positioning techniques, such as SL-RTT.

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

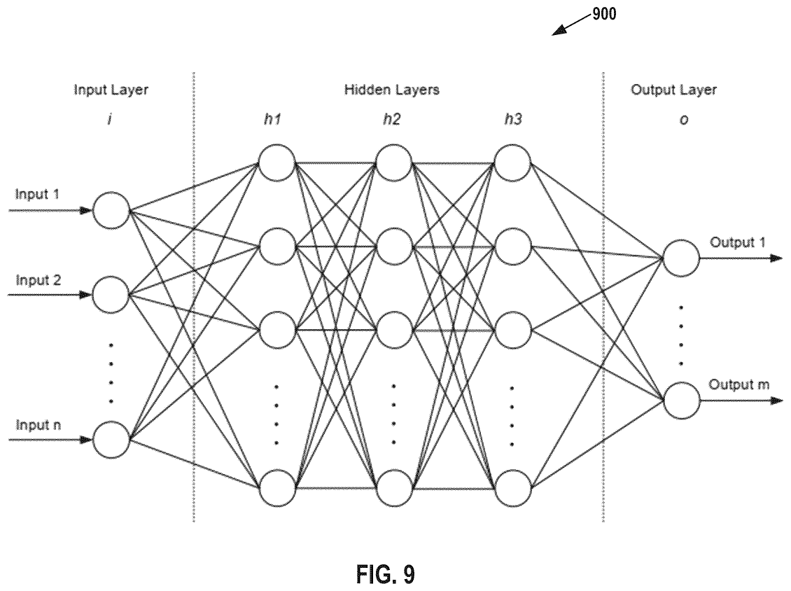

FIG. 9 illustrates an example neural network 900, according to aspects of the disclosure. The neural network 900 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

In some designs, a position estimation entity (e.g., UE, gNB, LMF, etc.) may utilize a direct AI/ML position estimation technique. In this case, a direct (D)-AI/ML model is trained so as to accept input data (e.g., DL-PRS measurements, UL-PRS measurements, SL-PRS measurements, etc.) that is processed to provide a position estimate of a UE as an output (i.e., a direct label).

In some designs, an assisted (or indirect) AI/ML position estimation technique is utilized. In this case, an assisted (A)-AI/ML model is trained so as to accept input data (e.g., DL-PRS measurements, UL-PRS measurements, SL-PRS measurements, etc.) that is processed to provide intermediate data as an output (i.e., or intermediate label, sometimes referred to as positioning feature extraction, such as timing/angle information, LOS identification, etc.), with the intermediate data in turn provided as an input to another position estimation model. Note that the other position estimation model may be another AI/ML model or a non-AI model (e.g., Chan's algorithm, a Kalman Filter (KF) algorithm, etc.). Also the A-AI/ML model and the another model may be implemented at the same entity (e.g., UE, LMF, etc.) or at different entities (e.g., for network-assisted positioning, UE applies the A-AI/ML model to compress the measurement data, which is then reported to the LMF, which then applies the other position estimation model; for UE-based positioning, network component such as gNB or LMF or another UE for sidelink applies the A-AI/ML model to compress the measurement data, which is then reported to the UE, which then applies the other position estimation model).

Note that, as used herein, an AI/ML model (e.g., A-AI/ML model or D-AI/ML model) may be alternatively referred to as an “ML model” or an “AI model” or an “ML-based model” or an “AI-based model,” and so on.

In example aspects, an ML model may be trained prior to, or at some point following, operation of the ML model, such as neural network 900, on input data. When training the ML model, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ML model has been configured by setting parameters, including weights and biases, from training data, the ML model's performance may be evaluated. In some scenarios, evaluation/verification tests may use a validation dataset, which may include data not in the training data, to compare the model's performance to baseline or other benchmark information. The ML model configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ML model by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent-based optimization algorithm and a stochastic gradient descent-based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ML model include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

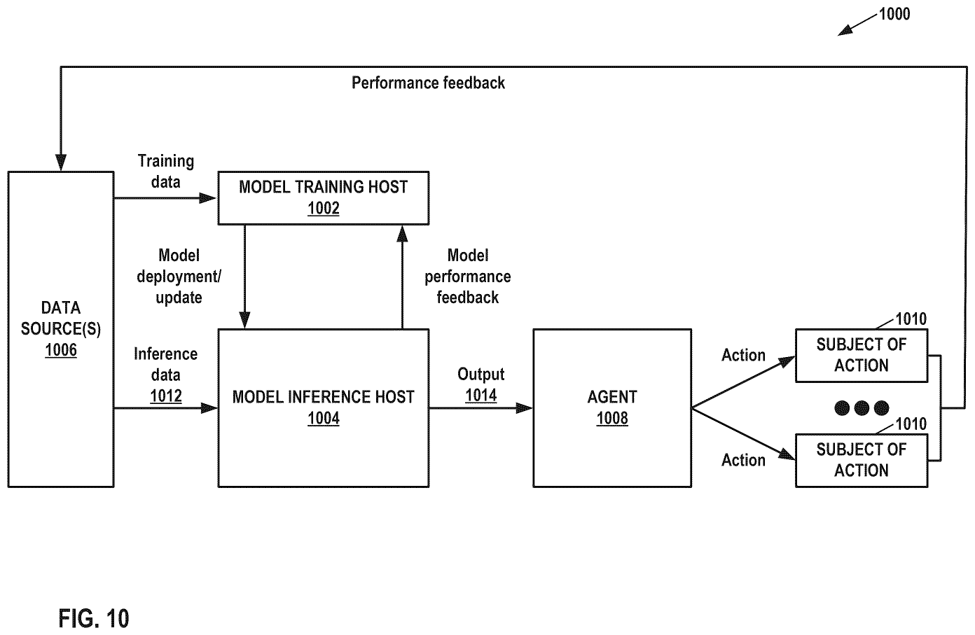

FIG. 10 is an illustrative block diagram of an example ML architecture 1000 that may be used for wireless communications in any of the various implementations, processes, environments, networks, or other use cases. As illustrated, architecture 1000 includes multiple logical entities, such as model training host 1002, model inference host 1004, data source(s) 1006, and agent 1008. Model inference host 1004 is configured to run an ML model based on inference data 1012 provided by data source(s) 1006. Model inference host 1004 may produce output 1014, which may include a prediction or inference, such as a discrete or continuous value based on inference data 1012, which may then be provided as input to the agent 1008.

Agent 1008 may represent an element or an entity of a wireless communication system including, for example, a radio access network (RAN), a wireless local area network, a device-to-device (D2D) communications system, etc. As an example, agent B08 may be a user equipment such as UE 104, a base station such as BS 102, or a disaggregated network entity (such as a centralized unit (CU), a distributed unit (DU), or a radio unit (RU), an access point, a wireless station, a RAN intelligent controller (RIC) in a cloud-based RAN, among some examples. Additionally, agent 1008 also may be a type of agent that depends on the type of tasks performed by model inference host 1004, the type of inference data 1012 provided to model inference host 1004, or the type of output 1014 produced by model inference host 1004.

Agent 1008 may perform one or more actions associated with receiving output 1014 from model inference host 1004. For instance, in examples where output 1014 indicates positioning data for a UE device, agent 1008 may provide positioning data to an application or another service. In examples where output 1014 is intermediate data, agent 1008 may perform a positioning process that uses the intermediate data to generate positioning data. Agent 1008 may provide the positioning data to an application or other service. Agent 1008 may indicate the one or more actions performed to at least one subject of action 1010. In some cases, agent 1008 and the subject of action 1010 are the same entity.

Data can be collected from data sources 1006 and may be used as training data 1016 for training an ML model, or as inference data 1012 for feeding an ML model inference operation. Data sources 1006 may collect data from various subject of action 1010 entities (such as, a UE or a network entity), and provide the collected data to a model training host 1002 for ML model training. In some examples, if output 1014 provided to agent 1008 is inaccurate (or the accuracy is below an accuracy threshold), model training host 1002 may provide feedback to model inference host 1004 to modify or retrain the ML model used by model inference host 1004, such as via an ML model deployment update.

Model training host 1002 may be deployed at the same or a different entity than that in which model inference host 1004 is deployed. For example, in order to offload model training processing, which can impact the performance of model inference host 1004, model training host 1002 may be deployed at a model server.

In some aspects, an ML model is deployed at or on a network entity (such as BS 102). More specifically, a model interference host, such as model inference host 1004 in FIG. 10, may be deployed at or on the network entity for such a gNB/TRP.

In some other aspects, an ML model is deployed at or on a UE (such as UEs 104, 152, 190, 164, 182). More specifically, a model inference host, such as model inference host 1004 in FIG. 10, may be deployed at or on the UE for generating output data (e.g., positioning data or intermediate data).

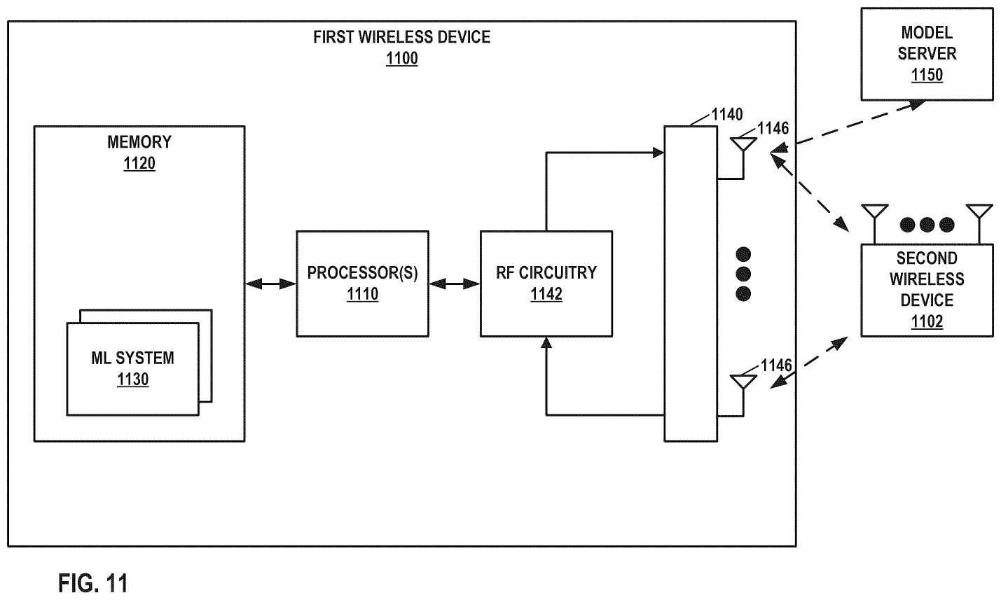

FIG. 11 is an illustrative block diagram of an example ML architecture of first wireless device 1100 in communication with second wireless device 1104. First wireless device 1100 may be configured for hosting a ML system for positioning of UE devices. Note that the example ML architecture of first wireless device 1100 may be applied to second wireless device 1102, and vice versa.

First wireless device 1100 may be, or may include, a chip, system on chip (SoC), chipset, package or device that includes one or more processors, processing blocks or processing elements (collectively “processor 1110”) and one or more memory blocks or elements (collectively “memory 1120”). Processor 1110 may be coupled to transceiver 1140, which includes radio frequency (RF) circuitry 1142 coupled to antennas 1146 via an interface for transmitting or receiving signals.

One or more ML models 1130 (collectively “ML system 1130”) may be stored in memory 1120 and accessible to processor(s) 1110. Individual or groups of ML models in ML system 1130 may be associated with respective model identifiers. In some aspects, different ML models of ML system 1130, which may optionally be associated with different model identifiers, may have different characteristics. One or more ML models of ML system 1130 may be selected based on respective features, characteristics, or applications, as well as characteristics or conditions of first wireless device 1100 (such as, a power state, a mobility state, a battery reserve, a temperature, etc.). For example, ML system 1130 may have different inference data and output pairings (such as, different types of inference data produce different types of output), different levels of accuracies associated with the predictions, different latencies associated with producing the predictions, different ML model sizes, different coefficients, different parameters, etc.

Processor 1110 may deploy ML system 1130 to produce respective output data based on input data. As an example, the ML models of ML system 1130 may take measurements of a reference signal (such as, corresponding to a wide beam) as input to predict a channel characteristic associated with a different reference signal (such as, corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, positioning data or intermediate data used by a positioning process to generate positioning data. In some aspects, a model server 1150 may perform various ML management tasks for first wireless device 1100 and/or second wireless device 1102.

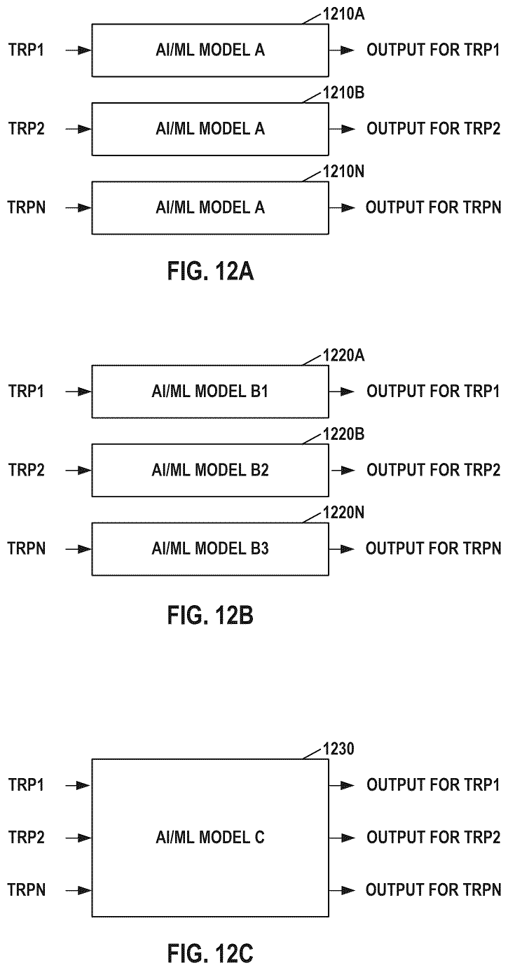

FIG. 12A, FIG. 12B, and FIG. 12C are block diagrams illustrating example styles of implementing AI/ML-assisted positioning systems. In the examples of FIG. 12A, FIG. 12B, and FIG. 12C, a network node or network entity, such as a UE device or LMF device, obtains data associated a set of TRPs (i.e., TRP 1, TRP 2, . . . , TRPN). The terms network node and network entity may be used interchangeably and may refer to a UE, base station, and/or LMF. For case of description, the following sections will use the term “network node” to refer to a UE, base station (e.g., gNB, eNB, etc.) or TRP, and will use the term network entity to refer to the device configured to determine UE positioning (e.g., a location server or LMF).

In one example, the network entity/node may obtain channel impulse response (CIR) data for signals generated by the TRPs. CIR data represents the response of the wireless channel to a brief input signal (impulse). CIR data provides detailed information about the multipath propagation characteristics, including delay spread and amplitude variations, phase of paths, power of paths, timing of paths, time of arrival of first path, time-of-flight, reference signal time difference, relative time of arrival, among other characteristics, which are useful for understanding and mitigating the effects of the wireless environment on signal transmission. In the example of FIG. 12A, the network entity/node implements different copies of the same AI/ML model (AI/ML model A 1210A, 1210B, . . . , 1210N) for different TRPs. Thus, when the network entity/node obtains data associated with a specific TRP, the network entity/node applies the AI/ML model associated with the specific TRP to the data associated with the specific TRP to generate output data associated with the specific TRP. The output data associated with the TRPs may include data that is used as input data to a process that determines the physical position of a UE device. For example, the output data may include Time of Arrival (ToA) data associated with the signal generated by the specific TRP.

In the example of FIG. 12B, the network entity/node implements different AI/ML models (AI/ML models 1220A, 1220B, . . . , 1220N) for different TRPs. The AI/ML models are not copies of one another. The AI/ML models may have the same inputs and outputs as the AI/ML models of FIG. 12A. In the example of FIG. 12C, the network entity/node implements a single AI/ML model 1230 that is trained to accept data associated with multiple TRPs as input.

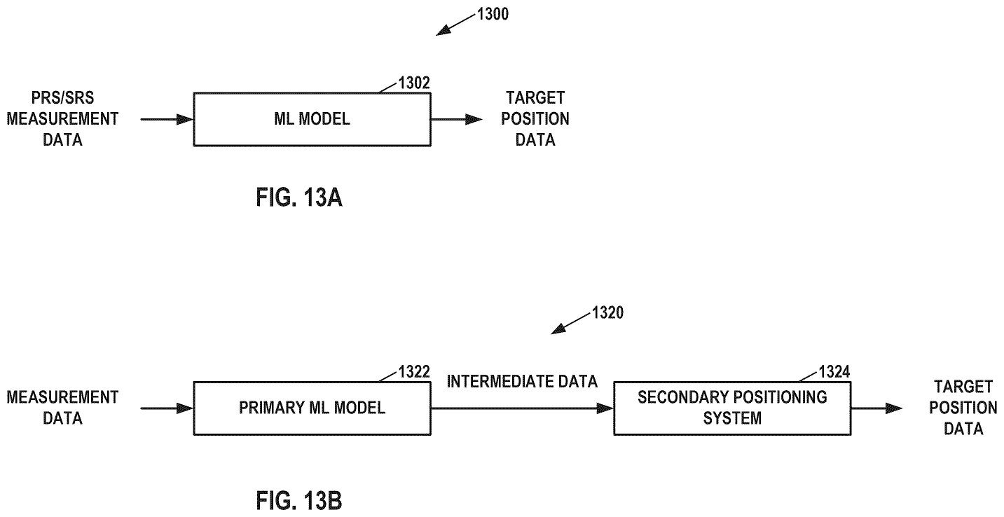

FIG. 13A is a block diagram illustrating an example of a direct positioning system 1300 in accordance with one or more techniques of this disclosure. In the example of FIG. 13A, a ML model 1302 receives PRS/SRS measurements and outputs a target location. ML model 1302 may be a ML model of ML system 1130 (FIG. 11). The target location is a position of a device whose position is being determined (i.e., the target device). In different examples, ML model 1302 may be implemented at a UE device, a gNB/TRP device, or a LMF device. Note that in this document, the terms position and location may be used interchangeably.

FIG. 13B is a block diagram illustrating an example of an indirect positioning system 1320 in accordance with one or more techniques of this disclosure. In the example of FIG. 13B, a primary ML model 1322 receives measurement data (e.g., PRS measurement data, SRS measurement data, etc.) and outputs intermediate data. The intermediate data include information that a secondary positioning system 1324 uses to determine a target location (i.e., the location of the target device). Example intermediate measurements may include information on the timing and angle of signals received by the target device, line of sight identification, and so on. Secondary positioning system 1324 may be implemented in one of a variety of ways. For example, secondary positioning system 1324 may be implemented using Chan's algorithm, Kalman Filtering (KF), an AI positioning model, or implemented in another way. Primary ML model 1322 is implemented at a target device (e.g., a UE device) or gNB/TRP device. Secondary positioning system 1324 may be implemented at the target device, a gNB/TRP, or LMF.

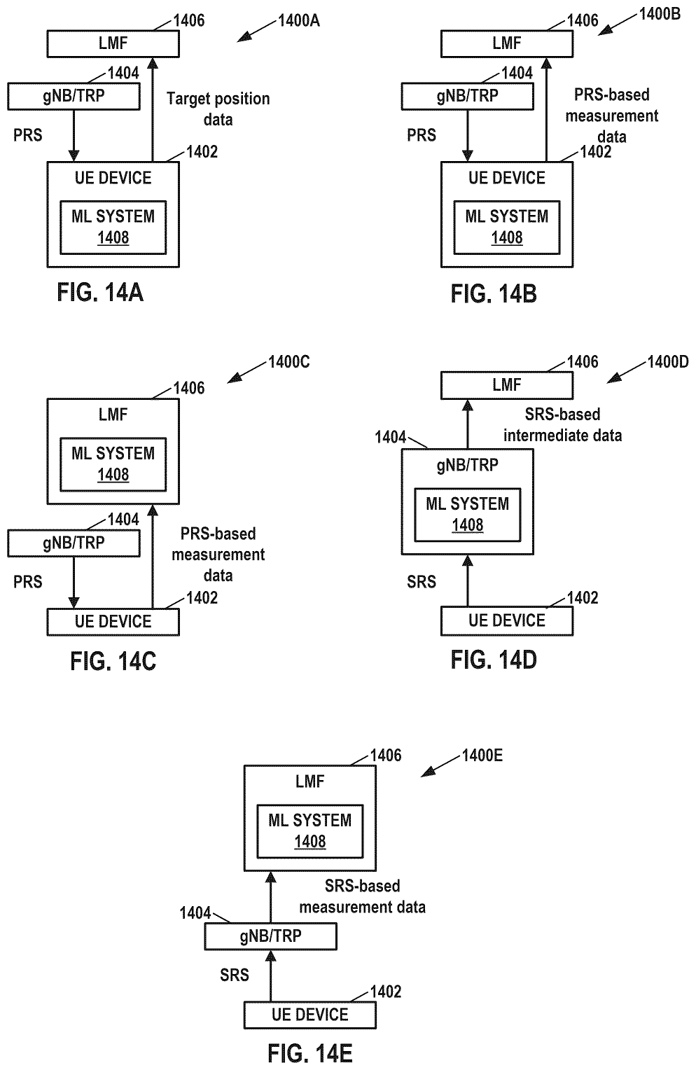

FIG. 14A is a block diagram illustrating a first example system 1400A in accordance with one or more techniques of this disclosure. In the example of FIG. 14A, a UE device 1402 includes a ML system 1408. UE device 1402 receives a PRS generated by gNB/TRP device 1404. UE device 1402 measures the PRS to generate measurement data. UE device 1402 applies ML system 1408 to the measurement data to generate target position data. UE device 1402 may send the target position data to LMF device 1406. System 1400A may be an example of a direct AI positioning system as described with respect to FIG. 13A.

FIG. 14B is a block diagram illustrating a second example system 1400B in accordance with one or more techniques of this disclosure. In the example of FIG. 14B, UE device 1402 includes a ML system 1408. UE device 1402 receives a PRS generated by gNB/TRP device 1404. UE device 1402 measures the PRS to generate measurement data. UE device 1402 applies ML system 1408 to the measurement data to generate PRS-based measurement data. UE device 1402 sends the PRS-based measurement data to LMF device 1406. LMF device 1406 may use the PRS-based measurement data to generate position data. Thus, system 1400B is an example of an AI-assisted positioning system as described with respect to FIG. 13B.

FIG. 14C is a block diagram illustrating a third example system 1400C in accordance with one or more techniques of this disclosure. In the example of FIG. 14C, UE device 1402 receives a PRS generated by gNB/TRP device 1404. UE device 1402 measures the PRS to generate PRS-based measurement data. UE device 1402 sends the PRS-based measurement data to LMF device 1406. LMF device 1406 implements a ML system 1408. LMF device 1406 may apply ML model 1902C to the PRS-based measurement data to generate position data. Thus, system 1400C is an example of a direct AI positioning system as described with respect to FIG. 13A.

FIG. 14D is a block diagram illustrating a fourth example system 1400D in accordance with one or more techniques of this disclosure. In the example of FIG. 14D, UE device 1402 generates an SRS. gNB/TRP device 1404 measures the SRS to generate measurement data. gNB/TRP device 1404 implements a ML system 1408. gNB/TRP device 1404 applies ML system 1408 to the measurement data to generate SRS-based intermediate data. gNB/TRP device 1404 sends the SRS-based intermediate data to LMF device 1406. LMF device 1406 may then use the SRS-based intermediate data to generate position data. Thus, system 1400D is an example of an AI-assisted positioning system as described with respect to FIG. 13B.

FIG. 14E is a block diagram illustrating a fifth example system 1400E in accordance with one or more techniques of this disclosure. In the example of FIG. 14D, UE device 1402 generates an SRS. gNB/TRP device 1404 measures the SRS to generate SRS-based measurement data. gNB/TRP device 1404 sends the SRS-based measurement data to LMF device 1406. LMF device 1406 implements ML system 1408. LMF device 1406 applies ML system 1408 to the SRS-based measurement data to generate position data. Thus, system 1400E is an example of a direct AI positioning system as described with respect to FIG. 13A.

In an AI/ML-based device positioning process, such as those described above with respect to FIGS. 14A-14E, one or more trained ML models are applied to measurement data in order to generate a position data (e.g., determine a location) for UE device 1402. The input data may represent aspects of wireless signals received by UE device 1402 or another network node. An advantage of such an AI/ML-based device positioning process is that the one or more AI/ML models of ML system 1408 may learn a function that maps the measurement data to positioning data in a manner that is less susceptible to errors caused by wireless signals following multiple paths.

As described above, UE device 1402, gNB/TRP device 1404, and/or LMF device 1406 may be configured to determine the location of a UE device 1402 based on measurements of reference signals. In some scenarios, such as non line-of-sight (NLOS) communications, machine learning AI/ML models have shown to be effective at helping determine the location of a UE. AI/ML models may be trained to generate output data, such as location data or intermediate data used as input to a secondary positioning process that generates the location data.

In some examples, a network node, such as UE device 1402 and/or gNB/TRP device 1404, may be configured to generate path measurement information for a first communication path between UE device 1402 and a TRP. The path measurement information may include timing information, power information, phase information, angle information, and/or LOS information. The network node may send the path measurement information to LMF device 1406 to determine a location of UE device 1402. In some examples, the network node (e.g., UE device 1402 and/or gNB/TRP device 1404) may be configured to generate first path measurement information as well as additional path measurement information. In some examples, LMF device 1406 may use the additional path measurement information to determine particular techniques to use to determine the location of the UE. However, the additional path measurement information may be ambiguous, and as such, the usefulness of the additional path measurement information may be limited.

As will be described in more detail below, this disclosure describes techniques that address this issue. As described herein, a network node, such as UE device 1402 and/or gNB/TRP device 1404, may be configured to send first path measurement information for a first path as well as additional path measurement information. The network node may be further configured to send an indication of a purpose (e.g., an information element) of the additional path measurement information to an LMF (e.g., LMF device 1406). The purpose of the additional path measurement information may be two or more of a legacy purpose, a second physical path (e.g., different from the first path), and/or a multi-hypotheses distribution of the first path. The first path may be an LOS direct path or an NLOS path. By knowing the purpose of the additional path measurement information, LMF device 1406 may determine a particular technique that best utilizes the additional path measurement information to determine a location of the UE. As such, LMF device 1406 may more accurately determine the location of a UE when using additional path measurement information.

Recent efforts have been made to study and possibly incorporate AI/ML positioning techniques in 3GPP standards. One area of study includes signaling and protocol aspects of Life Cycle Management (LCM) enabling functionality and model selection, activation, deactivation, switching, and fallback. Another area of study involves signaling and other mechanisms for LCM to facilitate model training, inference, performance monitoring, and data collection, as well as signalling mechanisms of applicable functionalities/models.

For model inference in AI-assisted positioning system, some studies have been directed to the type of information that may be output, the use of hard-representation information and/or soft-representation information, and whether model outputs can use some existing types of measurement reports. Example types of information that may be output by a model may include ToA, RSTD, AoD, AoA, and an LOS/NLOS indicator. As one example, an RSTD measurement may include calculating the time taken for a signal to travel from the transmitter (e.g., a base station) to the receiver (e.g., a user device) and back again. This RSTD measurement is beneficial for determining precise timing information, which enables synchronization, network optimization, and positioning. RSTD measurements help in estimating the distance between devices and the network infrastructure by analyzing the round-trip time, accounting for signal processing delays and propagation effects. Accurate RSTD measurements enhance the performance of various 5G applications, including location-based services, by providing reliable timing data necessary for high-precision operations.

In general, such measurement reports may be referred to as LOS and timing information. An LOS or NLOS indicator may identify whether or not there is a clear, unobstructed path between the transmitter and the receiver. This direct path allows the signal to travel in a straight line, resulting in minimal attenuation and distortion. LOS conditions are ideal for achieving high data rates, low latency, and reliable communication, as the signal strength remains strong and consistent. LOS information enables accurate positioning techniques like Angle of Arrival (AoA) and Time of Arrival (ToA), where measurements of the signal's angle and time of travel are used to determine the device's location accurately.

Timing information involves the measurement of the time it takes for signals to travel between the transmitter and the receiver. This information is used for various functions, including synchronization, data transfer, and positioning. Techniques such as TDOA and Round-Trip Time (RTT) use timing information to calculate the distance between devices and base stations. Precise timing helps in mitigating interference, optimizing resource allocation, and enhancing network performance. In positioning, timing information combined with LOS data enables high-accuracy location services by providing detailed information about the signal propagation characteristics and the environment's impact on signal travel.

In some examples, the LOS or NLOS indicator or other timing information may be represented by a hard-representation or a soft-representation. Both hard-representation and soft-representation of LOS information and timing information refer to different approaches for handling and utilizing these data types. A hard-representation of LOS information involves a binary or categorical classification indicating whether a direct, unobstructed path exists between the transmitter and receiver or not. A hard-representation typically classifies links as either LOS or NLOS, often based on predefined criteria or thresholds such as signal strength or the presence of obstacles. As one example, a base station might classify a connection as LOS if the signal strength exceeds a certain threshold and no known physical obstructions are present in the signal path.

A hard-representation of timing information may include precise, discrete measurements of signal travel time. The hard-representation of timing information may rely on exact timestamps for signal transmission and reception, often used for synchronization and positioning. As one example, TDOA methods may measure the exact time difference between signals arriving at different base stations to calculate the position of a device.

A soft-representation of LOS information involves a probabilistic or continuous assessment of the likelihood that a path is LOS or NLOS. The soft-representation approach may provide a confidence level or probability score indicating how likely it is that a given path is LOS, accounting for uncertainties and varying conditions. A soft-representation might use machine learning models to estimate a probability score (e.g., 0.8 for 80% likelihood) that a signal path is LOS based on factors like signal strength, multipath characteristics, and environmental data.

A soft-representation of timing information may include estimated or averaged values, often with associated uncertainties or error margins. The soft-representation of timing information accounts for the inherent variability and potential errors in timing measurements, providing more robust data for applications like positioning. As one example, instead of relying on a single timestamp, a soft-representation might provide an average signal travel time with a confidence interval (e.g., 10.2 milliseconds±0.5 milliseconds), indicating the expected accuracy and reliability of the timing information.

Accordingly, for AI/ML-assisted positioning, evaluations are carried out where the model output includes timing information and/or an LOS/NLOS indicator in the format of a hard-representation value or a soft-representation value. In addition, for AI/ML assisted positioning with UE-assisted positioning (e.g., FIG. 14B) and NG-RAN node assisted positioning (e.g., FIG. 14D), evaluations are being explored regarding the measurement report to carry model output to an LMF, possible new measurement reports (e.g., ToA, path phase, etc.), existing measurement reports to use (e.g., RSTD, LOS/NLOS indicator, RSRPP), and enhancement of existing measurement reports (e.g., soft-representation information and/or higher resolution of RSTD information).

As noted above, AI/ML positioning techniques have shown show excellent positioning accuracy in stringent NLOS conditions. Stringent NLOS conditions may refer to scenarios where the direct path between the transmitter and receiver is obstructed by physical barriers like buildings or trees, leading to severe signal attenuation, multipath propagation, and increased delay spread. These conditions degrade signal strength, positioning accuracy, and overall communication quality due to weaker received signals, interference, and unpredictable signal behavior. To mitigate these challenges, 5G NR may include advanced techniques such as beamforming, massive MIMO, higher frequency bands, and sophisticated signal processing, alongside hybrid positioning systems that integrate multiple technologies for enhanced reliability and precision in obstructed environments.

For AI-assisted positioning systems, such as those described above with reference to FIG. 14B and FIG. 14D, UE device 1402 and/or gNB/TRP device 1404 may be configured to report LOS information and/or timing information in a hard-representation or a soft-representation. One possible way to send information in a soft-representation is a mutlti-hypotheses probability distribution representation. In the context of a soft-representation, a multi-hypotheses probability distribution refers to the indication of multiple potential outcomes or scenarios to describe the likelihood of different states or events. Example probability distribution models that may be used with a multi-hypotheses probability distribution may include a Gaussian mixture model (GMM), where multiple Gaussian distributions are combined to model the overall probability distribution. Another example distribution model may use a set of samples to represent the distribution of possible states, updating the probabilities based on new measurements. This approach may be particularly useful in situations where there is significant uncertainty or variability, such as in the assessment of LOS conditions and timing information.

A multi-hypotheses probability distribution represents a range of possible outcomes, each with an associated probability, rather than a single deterministic value. A multi-hypotheses probability distribution approach captures the inherent uncertainty and provides a comprehensive picture of the possible scenarios, allowing for more informed decision-making. As one example, instead of classifying a link as simply LOS or NLOS, a multi-hypotheses approach would consider various potential conditions with different probabilities. For example, a multi-hypotheses approach might include a first hypothesis with a high likelihood of LOS (e.g., 70% probability), a second hypothesis with a moderate likelihood of LOS with minor obstructions (e.g., 20% probability), and a third hypothesis with a low likelihood of LOS with significant obstructions (e.g., 10% probability). This approach for a more nuanced understanding of the signal environment, accommodating varying degrees of obstruction and environmental factors.

As another example for timing information, multiple hypotheses could represent different possible travel times, each with a certain probability. This approach captures the variability in timing measurements due to factors like multipath propagation, signal interference, and measurement noise, providing a richer dataset for positioning and synchronization tasks.

As a more specific example, an RSTD measurement of a first physical path can be expressed as a mixture of Gaussian distributions in which each distribution is represented using three tuples (mean, variance or standard deviation, and weight). The mean in this context refers to the average timing information obtained from multiple measurements or hypotheses. The mean represents the central point of the timing data, indicating the most likely timing estimate. In location determination, this would be the average RSTD of signals from various reference points. The variance or standard deviation measures the spread or dispersion of the timing information around the mean. A lower variance indicates that the timing measurements are closely clustered around the mean, suggesting high precision and reliability in the timing information. Conversely, a higher variance implies greater uncertainty and less reliability in the measurements. In practical terms, variance helps to assess the confidence level in the timing data used for location determination. The weight in a multi-hypotheses distribution assigns importance to each hypothesis or measurement. Different hypotheses might have different levels of confidence or reliability based on factors such as signal strength, signal-to-noise ratio (SNR), or the quality of the timing synchronization. Weights are used to prioritize more reliable measurements over less reliable ones, ensuring that the location determination algorithm gives more importance to high-quality timing information.

Existing specifications allow a UE or base station to report timing and LOS measurements for a first path and up to additional 8 paths. However, such specifications are agnostic to whether these reported additional paths would correspond to additional estimates of first path RSTD (e.g., multi-hypotheses distributions), actual additional physical paths (e.g., a second physical path, a third physical, etc.) or some other type of path measurement information. Any timing or LOS information in an additional path measurement report sent in accordance with existing specifications are undefined. As such, when an LMF receives an additional path measurement report from a UE or base station, the LMF is unable to determine whether the reports are actual additional paths or information for the first path expressed as multi-hypotheses probability distributions.

In view of these drawbacks, this disclosure describes techniques for indicating a purpose (e.g., type or meaning) of additional path measurement reporting from either UE device 1402 or gNB/TRP device 1404. As described herein, a network node, such as either UE device 1402 or gNB/TRP device 1404, may be configured to send first path measurement information for a first path as well as additional path measurement information. The network node may be further configured to send an indication of a purpose (e.g., an information element) of the additional path measurement information to LMF device 1406. The purpose of the additional path measurement information may be two or more of a legacy purpose (e.g., undefined additional path measurement information), measurement information for a second physical path (e.g., a path different from the first path), and/or a multi-hypotheses distribution of the first path. The first path may be an LOS direct path or an NLOS path. The additional path measurement information may be sent using both LTE Positioning Protocol (LPP) signaling and NR Positioning Protocol A (NRPPa) signaling.

In one example, UE device 1402 or gNB/TRP device 1404 may send first path measurement information in a syntax element called NR-DL-TDOA-MeasElement-r16. Note that R16 refers to Release 16 and may be different for other Release versions. NR-DL-TDOA-MeasElement-r16 is part of the measurement reporting framework used for location services within the 5G system. The NR-DL-TDOA-MeasElement-r16 element is related to the Time Difference of Arrival (TDOA) measurements for downlink signals, which are used for positioning and location determination of a UE. The NR-DL-TDOA-MeasElement-r16 may include syntax elements for indicating an RSTD (e.g., nr-RSTD-r16), a timing quality (nr-TimingQuality-r16), and LOS/NLOS (e.g., nr-los-nlos-Indicator-r17).

UE device 1402 or gNB/TRP device 1404 may send additional path measurement information in a NR-DL-TDOA-AdditionalMeasurementElement-r16 syntax element. NR-DL-TDOA-AdditionalMeasurementElement-r16 is designed to support enhanced positioning capabilities by providing additional measurement information related to the TDOA in downlink signals. The NR-DL-TDOA-AdditionalMeasurementElement-r16 may also include syntax elements for indicating an RSTD (e.g., nr-RSTD-ResultDiff-r16), a timing quality (nr-TimingQuality-r16), and LOS/NLOS (e.g., nr-los-nlos-IndicatorPerResource-r17).

The elements nr-RSTD-r16 or nr-RSTD-ResultDiff-r16 include parameters and configurations used by UE device 1402 or gNB/TRP device 1404 to measure and report the RSTD. The element nr-TimingQuality-r16 includes information elements and configurations that define the expected or required timing accuracy for various network functions. The elements nr-los-nlos-Indicator-r17 or nr-los-nlos-IndicatorPerResource-r17 include information about the propagation conditions between a UE and gNB/TRP and indicates whether the signal path is LOS or NLOS.

LPP is a protocol used for exchanging positioning information between a UE and an LMF, initially developed for LTE but also applicable to 5G. LPP supports various positioning methods, such as GNSS and OTDOA, allowing the network to determine the location of a device by collecting and processing different types of positioning measurements. NRPPa, on the other hand, is a specific protocol designed for positioning in 5G NR. NRPPa extends the capabilities of LPP to support advanced features and requirements of 5G networks. NRPPa facilitates the exchange of positioning information between a device (e.g., UE or gNB) and the 5G network (e.g., LMF), enabling the use of advanced positioning techniques like 5G NR-specific OTDOA, UTDOA, and multi-cell coordination.

This disclosure also describes specific techniques for sending a multi-hypotheses probability distribution in LPP/NRPPa. For example, UE device 1402 or gNB/TRP device 1404 may be configured repurpose existing additional path reporting to indicate soft-representation information of a first path as a multi-hypotheses probability distribution. For example, when sending an additional path measurement report, UE device 1402 or gNB/TRP device 1404 may use an RSTD field (e.g., nr-RSTD-r16 or nr-RSTD-ResultDiff-r16) to indicate the mean value, a timing quality field (e.g., nr-TimingQuality-r16) to indicate the variance/standard deviation, and an LOS field with soft-representation (e.g., nr-los-nlos-Indicator-r17 or nr-los-nlos-IndicatorPerResource-r17) to indicate the weight for the probability distribution.

By determining the purpose and physical meaning of the additional path measurement, LMF device 1406 may determine a particular technique to utilize the additional path measurement information to determine a location of UE device 1402. As such, LMF device 1406 may more accurately determine the location of UE device 1402 when using additional path measurement information. Accordingly, in one example of this disclosure, when sending additional path measurement information, UE device 1402 or gNB/TRP device 1404 may be further configured to send an indication of the purpose of the additional path measurement information to LMF device 1406.

If the indication of purpose indicates that the additional path measurement information is for actual physical paths (e.g., second paths different from the first path associated with the first path information), LMF device 1406 may be configured to use an outlier rejection technique to determine the location of UE device 1402 using the additional path measurement information. In general, outlier rejection may include identifying and excluding erroneous or extreme measurement values that deviate significantly from the expected range of measurements. These outliers can arise due to various factors such as signal reflections (multipath effects), interference, hardware malfunctions, or environmental conditions. By rejecting these outliers, LMF device 1406 can improve the accuracy of the location estimates.

One example outlier rejection technique is random sample consensus (RANSAC), which is an iterative algorithm used for robustly estimating the position of a UE by fitting a model to location-related measurements (e.g., ToA, TDoA) while minimizing the impact of outliers. By randomly sampling subsets of measurements and identifying the model with the most consensus inliers, RANSAC enhances the accuracy and reliability of positioning in noisy and dynamic environments.

If the indication of purpose indicates that the additional path measurement information is a multi-hypotheses distribution of the first physical path, LMF device 1406 may be configured to use a likelihood fusion technique to determine the location of the UE device 1402 using the additional path measurement information. Likelihood fusion may include combining multiple measurements or hypotheses about the position a UE to improve location accuracy. LMF device 1406 collects various data points from the first path measurement information and the multi-hypotheses distributions of the additional path measurement information. Each measurement provides a likelihood function (e.g., the weight) indicating the probability of the UE being at different locations based on that measurement. Likelihood fusion integrates these individual likelihood functions to form a combined likelihood distribution, which enhances the precision and reliability of the UE's estimated position by leveraging the strengths of multiple measurements.

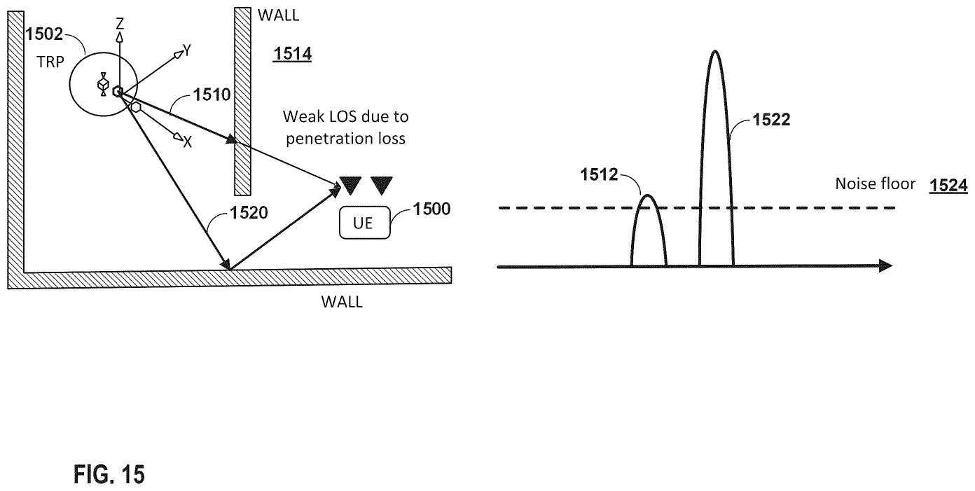

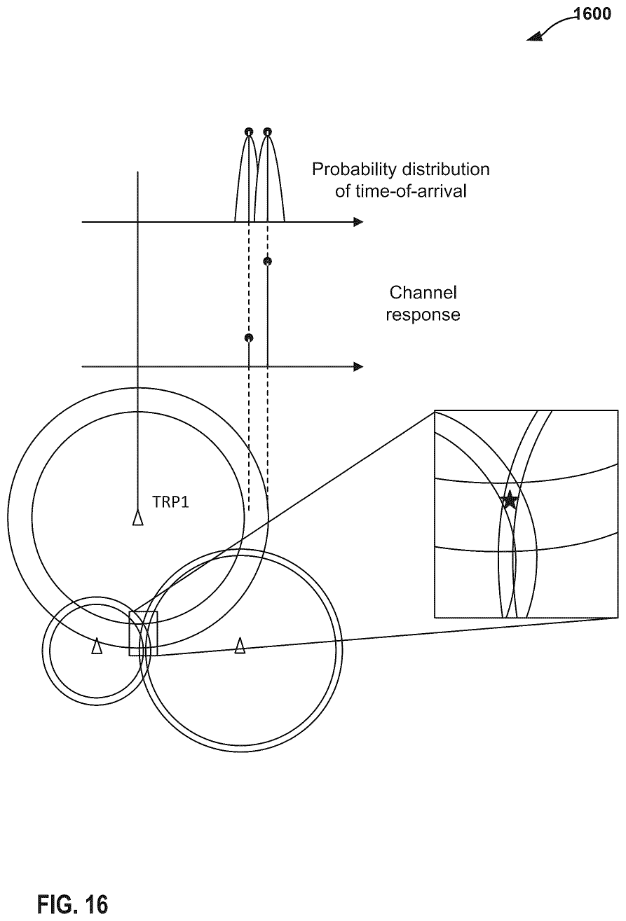

FIG. 15 is a conceptual diagram illustrating an NLOS path between a UE and a TRP. FIG. 15 shows an example of a challenging positioning scenario that motivates the need for multi-hypotheses positioning measurement reporting. In FIG. 15, a TRP 1502 emits an RF signal. A portion of the RF signal follows a LOS path 1510 and a portion of the RF signal follows a NLOS path 1520. As such, UE 1500 receives an LOS component 1512 and a NLOS component 1522 of the RF signal. A portion of the RF signal that follows LOS path 1510 from TRP 1502 to UE 1500 is highly attenuated by a wall 1514. The signal strength of LOS component 1512 is near a noise floor 1524 (e.g., a level at which a signal cannot be differentiated from noise) and is very weak. The weak signal from LOS component 1512, can hinder an ability of UE 1500 to determine whether LOS path 1510 or NLOS path 1520 (which has a stronger NLOS component 1522) is the actual LOS. Rather than reporting the peak from LOS component 1512 or NLOS component 1522, UE 1500 can report multiple hypotheses of LOS and timing indications. FIG. 16 is a conceptual diagram 1600 illustrating positioning with three TRPs. FIG. 16 illustrates uncertainty associated with LOS and timing information when positioning with three TRPs and associated potential of combining these uncertainties with likelihood fusion.

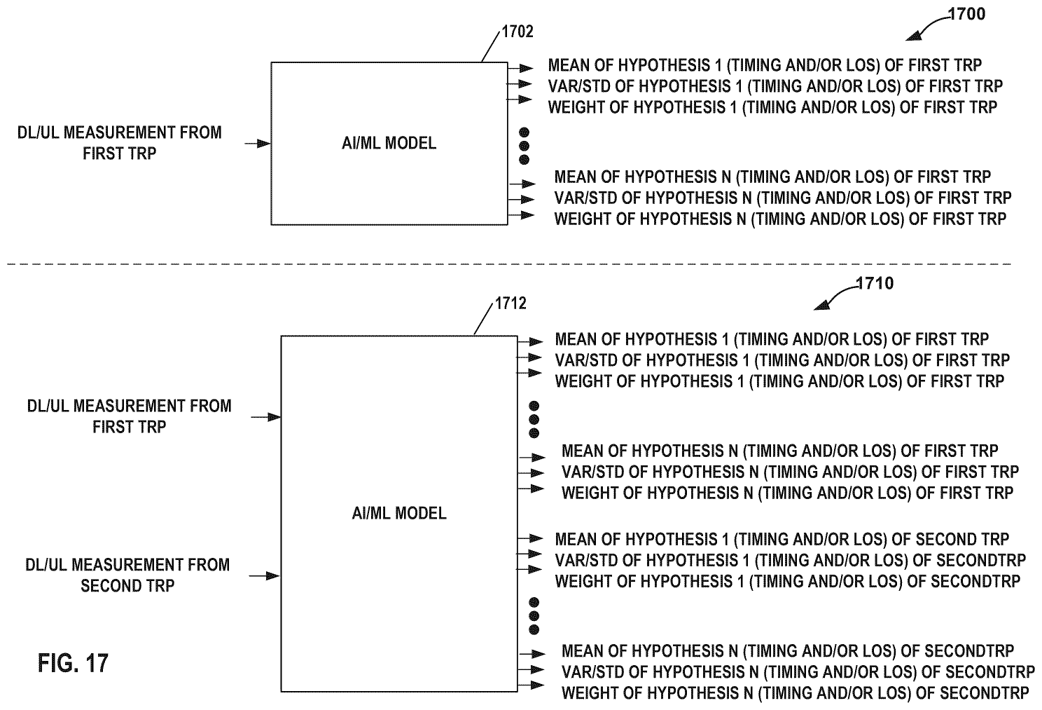

FIG. 17 is a block diagram illustrating examples of determining additional path measurements in accordance with one or more techniques of this disclosure. In scenario 1700, AI/ML model 1702 (e.g., executed by UE device 1402 or gNB/TRP device 1404) may receive either a downlink (DL) measurement or an uplink (UL) measurement from a TRP (e.g., a UE or gNB). A DL measurement may be from a PRS (e.g., FIG. 14B), while the UL measurement may be from an SRS (e.g., FIG. 14D). The measurement may be expressed as CIR data, power delay profile (PRP), or delay profile (DP). The output of AI/ML model 1702 is soft-representation information representing multi-hypotheses probability distributions. As shown in scenario 1700, the multi-hypotheses probability distributions include 1 through N reports, each with a mean, variance/standard deviation (var/std), and weights, for a path from a first TRP.

In scenario 1710, AI/ML model 1712 (e.g., executed by UE device 1402 or gNB/TRP device 1404) may receive either downlink (DL) measurement or uplink (UL) measurement from multiple TRPs (e.g., a UE or gNB). A DL measurement may be from a PRS (e.g., FIG. 14B), while the UL measurement may be from an SRS (e.g., FIG. 14D). The measurement may be expressed as CIR data, PRP, or DP. The output of AI/ML model 1712 is soft-representation information representing multi-hypotheses probability distributions. As shown in scenario 1710, the multi-hypotheses probability distributions include 1 through N reports, each with a mean, variance (var/std), and weights, for a path from a first TRP, as well as 1 through N reports, each with a mean, variance (var/std), and weights, for a different path from a second TRP

As described above, the additional path measurement reports generated by UE device 1402 or gNB/TRP device 1404 can have different types or purposes. To support LMF device 1406 determining techniques to use to utilize the additional path measurement reports, UE device 1402 or gNB/TRP device 1404 may generate and second an indication (e.g., an information clement) that indicates the additional path measurement purposes. Possible purposes may include two or more of the following:
Legacy Purpose: Additional path(s) measurements should be treated according to their meaning up to Rel18 (e.g., agnostic meaning).
Physical paths: Additional path(s) measurements are actual physical paths (e.g., 2^{nd} path, 3^{rd} path, 4^{th} path, etc.). For example, a second physical path different from the first physical path associated with a first measurement report.
Multi-hypotheses distribution: Additional path(s) measurements are multi-hypotheses probability distributions of the first path and/or LOS direct path.

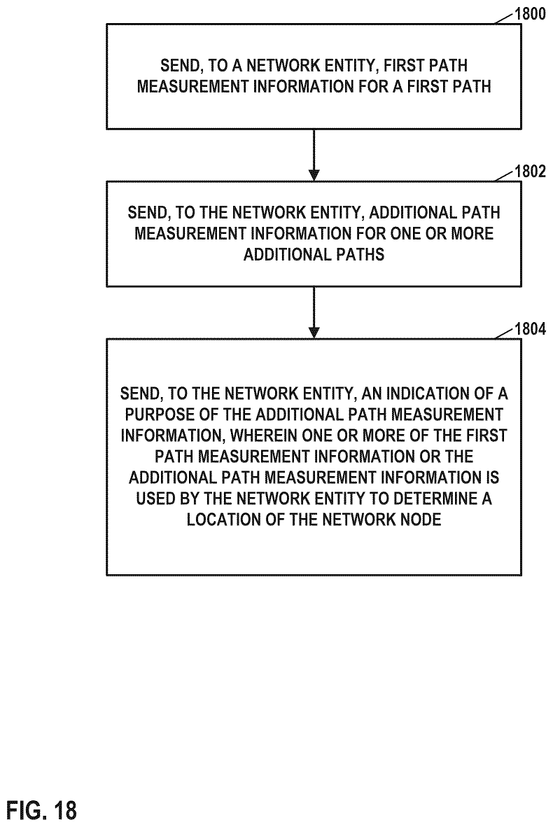

FIG. 18 is a flowchart illustrating an example operation of a network node in accordance with one or more techniques of this disclosure. In the context of this example, the network node may be either a UE (e.g., UE device 1402 of FIGS. 14A-14E) or a base station/TRP (e.g., gNB/TRP device 1404 of FIGS. 14A-14E). In one example of the disclosure, the network node may include a memory, and one or more processors implemented in circuitry, wherein the one or more processors are communicatively coupled to the memory. The one or more processors are configured to cause the network node to perform the following processes. For example, the network node may be configured to send, to a network entity (e.g., LMF device 1406 of FIGS. 14A-14E), first path measurement information for a first path (1800), and send, to the network entity, additional path measurement information for one or more additional paths (1802).

The network node may be configured to determine one or more of the first path measurement information or the additional path measurement information using an AI/ML process. For example, when the network node is a UE, the UE may be configured to determine the first path measurement information or the additional path measurement information as shown in FIG. 14B. When the network node is a base station (e.g., gNB or TRP), the base station may be configured to determine the first path measurement information or the additional path measurement information as shown in FIG. 14D.

The network node may be further configured to send, to the network entity, an indication of a purpose of the additional path measurement information, wherein one or more of the first path measurement information or the additional path measurement information is used by the network entity to determine a location of the network node (1804).

In the above examples, the purpose of the additional path measurement information may be two or more of a legacy purpose, measurement information for a second path, and a multi-hypotheses distribution of the first path, wherein the second path is different from the first path, and wherein the first path is one of an LOS direct path or an NLOS path.

In an example where the purpose is the multi-hypotheses distribution of the first path, the additional path measurement information may include one or more of timing information, power information, phase information, angle information, or LOS information, wherein the timing information and the LOS information include a mean, a variance, and a weight. In this example, UE device 1402 may be configured to send, to the network entity (e.g., LMF device 1406), the mean of the timing information or the LOS information in an RTSD field of downlink TDOA syntax, the variance of the timing information or the LOS information in a timing quality field of the downlink TDOA syntax, and the weight of the timing information or the LOS information in a LOS indicator field with soft representation of the downlink TDOA syntax.

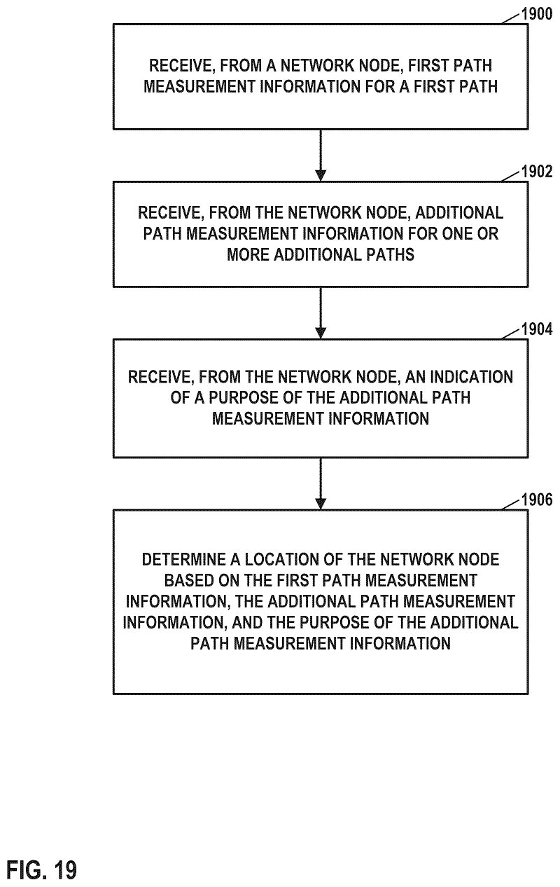

FIG. 19 is a flowchart illustrating an example operation of a network entity in accordance with one or more techniques of this disclosure. In the context of this example, the network entity may be LMF device 1406 of FIGS. 14A-14E. The network node may be either a UE (e.g., UE device 1402 of FIGS. 14A-14E) or a base station/TRP (e.g., gNB/TRP device 1404 of FIGS. 14A-14E). In one example of the disclosure, the network entity may receive, from a network node, first path measurement information for a first path (1900), and receive, from the network node, additional path measurement information for one or more additional paths (1902).

The network node may be configured to determine one or more of the first path measurement information or the additional path measurement information using an AI/ML process. For example, when the network node is a UE, the UE may be configured to determine the first path measurement information or the additional path measurement information as shown in FIG. 14B. When the network node is a base station (e.g., gNB or TRP), the base station may be configured to determine the first path measurement information or the additional path measurement information as shown in FIG. 14D.

The network entity (e.g., LMF device 1406) may be further configured to receive, from the network node, an indication of a purpose of the additional path measurement information (1906). The purpose of the additional path measurement information may be two or more of a legacy purpose, a second path, and a multi-hypotheses distribution of the first path, wherein the second path is different from the first path, and wherein the first path is one of an LOS direct path or an NLOS path.

In an example where the purpose is the multi-hypotheses distribution of the first path, and the additional path measurement information includes one or more of timing information or LOS information, and the timing information and the LOS information include a mean, a variance, and a weight. In this example, the network entity may be further configured to receive, from the network node, the mean of the timing information or the LOS information in a reference signal time of arrival (RTSD) field of downlink time difference of arrive (TDOA) syntax, the variance of the timing information or the LOS information in a timing quality field of the downlink TDOA syntax, and the weight of the timing information or the LOS information in a LOS indicator field with soft representation of the downlink TDOA syntax.

The network entity (e.g., LMF device 1406) may be further configured to determine a location of the network node based on the first path measurement information, the additional path measurement information, and the purpose of the additional path measurement information (1906). In one example, the network entity is configured to determine the location of the network node using outlier rejection based on the purpose of the additional path measurement information being a second path, wherein the second path is different from the first path, and wherein the first path is one of an LOS direct path or an NLOS path. In another example, the network entity is configured to determine the location of the network node using likelihood fusion based on the purpose of the additional path measurement information being a multi-hypotheses distribution of the first path, wherein the first path is one of an LOS direct path or an NLOS path.

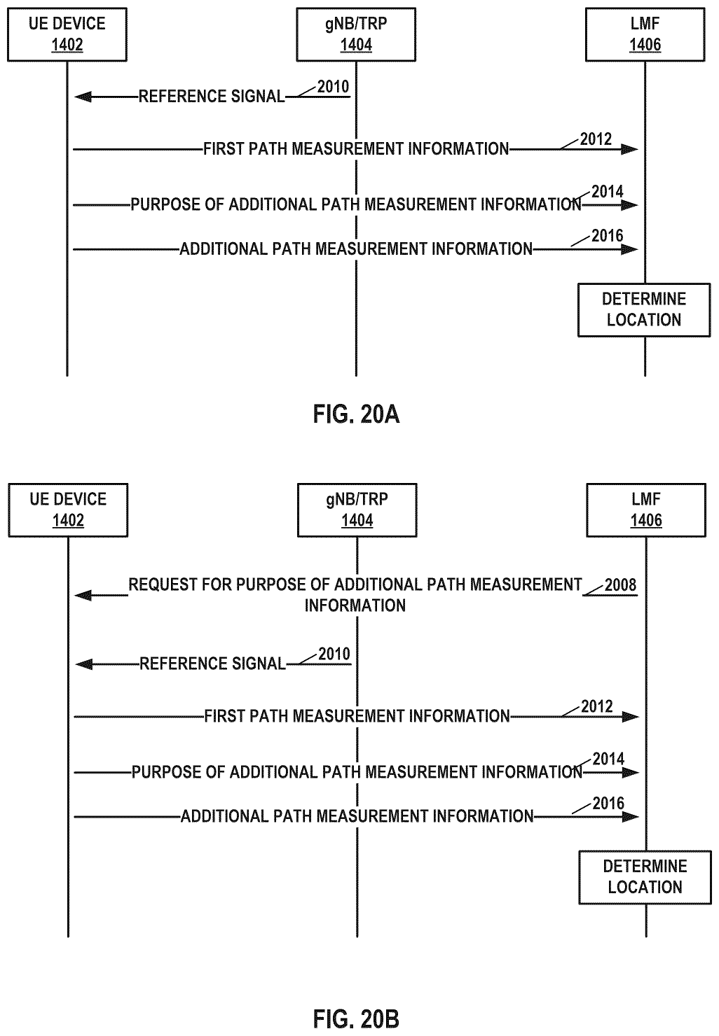

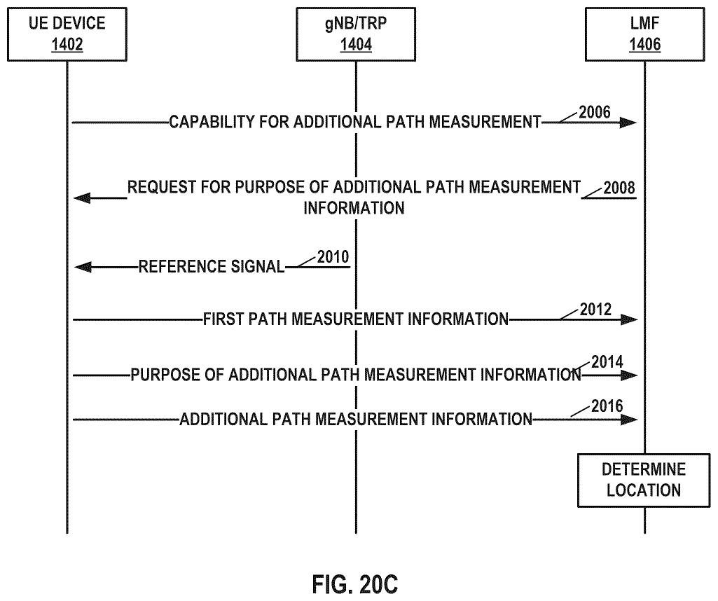

FIGS. 20A-20C are communication diagrams illustrating examples of indicating a purpose of an additional path measurement between a UE and an LMF in accordance with one or more techniques of this disclosure. FIG. 20A is a communication diagram illustrating a first example data exchange between UE device 1402, gNB/TRP device 1404, and LMF device 1406, in accordance with one or more techniques of this disclosure. The data exchange of FIG. 20A is consistent with system 1400B of FIG. 14B. In the example of FIG. 20A, UE device 1402 is configured to send an LPP Provide Location signaling (e.g., purpose of additional path measurement information 2014) to LMF device 1406. The LPP Provide Location signaling indicates the type/purpose of the additional path measurement being reported As one example, LPP Provide Location signaling may have one of three integer values. A value of 0 indicates a legacy purpose, a value of 1 indicates a second physical path, and a value of 2 indicates a multi-hypotheses probability distribution of a first path or an LOS direct path.

In the example of FIG. 20A, UE device 1402 may receive reference signal 2010 (e.g., PRS) from gNB/TRP device 1404 over a first path. UE device 1402 may generate first path measurement information 2012 and send first path measurement information 2012 to LMF device 1406. UE device 1402 may generate additional path measurement information 2016. Additional path measurement information 2016 may be for a second physical path or multi-hypotheses probability distributions of the first path. UE device 1402 may further send purpose of additional path measurement information 2014 (e.g., the LPP Provide Location signaling) indicating the purpose of additional path measurement information 2016. LMF device 1406 may determine the location of UE device 1402 based on first path measurement information 2012, purpose of additional path measurement information 2014, and additional path measurement information 2016.

The example of FIG. 20A shows first path measurement information 2012, purpose of additional path measurement information 2014, and additional path measurement information 2016 as separate information elements. In some examples, each of the first path measurement information 2012, purpose of additional path measurement information 2014, and additional path measurement information 2016 may be signaled together in a single data structure. Furthermore, first path measurement information 2012, purpose of additional path measurement information 2014, and additional path measurement information 2016 may be sent in any order.

FIG. 20B is a communication diagram illustrating a first example data exchange between UE device 1402, gNB/TRP device 1404, and LMF device 1406, in accordance with one or more techniques of this disclosure. The data exchange of FIG. 20B is consistent with system 1400B of FIG. 14B. In the example of FIG. 20B, UE device 1402 is configured to operate in the same manner as FIG. 20A. However, LMF device 1406 may be configured to send LPP Request Location signaling (e.g., request purpose of additional path measurement information 2008) to UE device 1402. The LPP Request Location signaling request a particular type or purpose of additional paths measurements to be reported by UE device 1402. As a further example, the LPP Request Location signaling may further include a request for the type of distribution (e.g., Gaussian, exponential, Rayleigh, etc.) in the case a multi-hypotheses probability distribution purpose is requested.

Furthermore, through the LPP request Location signaling, LMF device 1406 can prioritize the type/purpose of additional paths measurement to be obtained and reported by UE device 1402. UE device 1402 can consider this prioritization when measuring and reporting additional paths measurements (e.g., prioritize multi-hypotheses over physical paths or vice versa).

FIG. 20C is a communication diagram illustrating a first example data exchange between UE device 1402, gNB/TRP device 1404, and LMF device 1406, in accordance with one or more techniques of this disclosure. The data exchange of FIG. 20C is consistent with system 1400B of FIG. 14B. In the example of FIG. 20C, UE device 1402 is configured to operate in the same manner as FIG. 20B. However, UE device 1402 is further configured to send LPP Capability signaling (e.g., capability for additional path measurement 2006) to LMF device 1406 to indicate the type/purpose of additional path measurement being supported by UE device 1402. LMF device 1406 may use this information to determine the content for request for purpose of additional path measurement information 2008. The LPP Capability signaling may also include the supported probability distributions (e.g., Gaussian, exponential, Rayleigh, etc.) by UE device 1402.

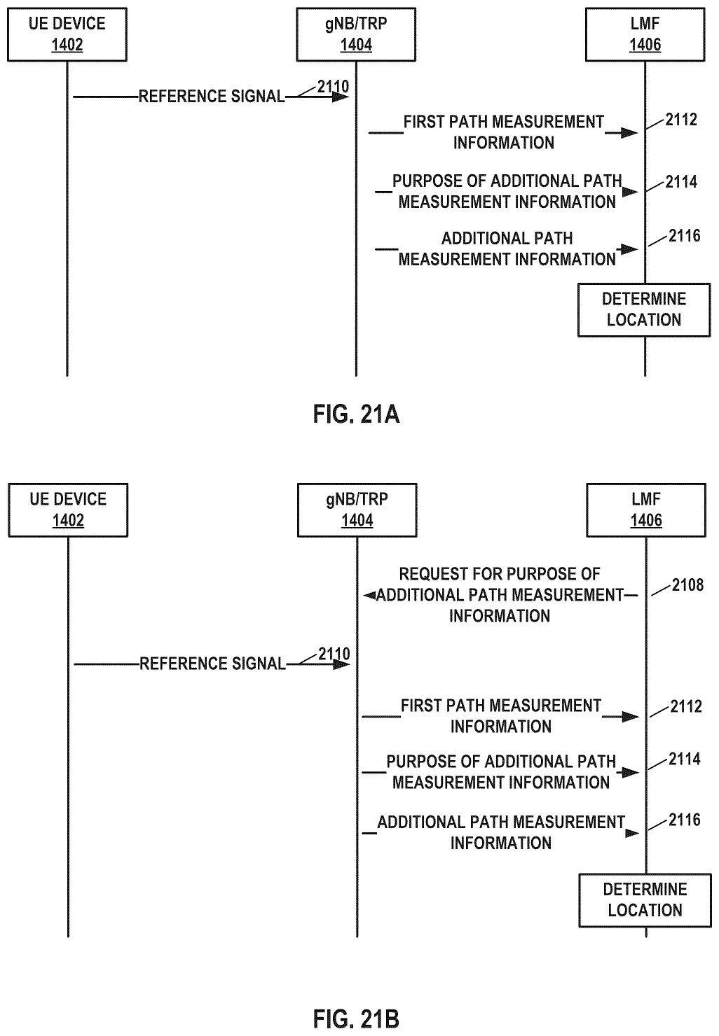

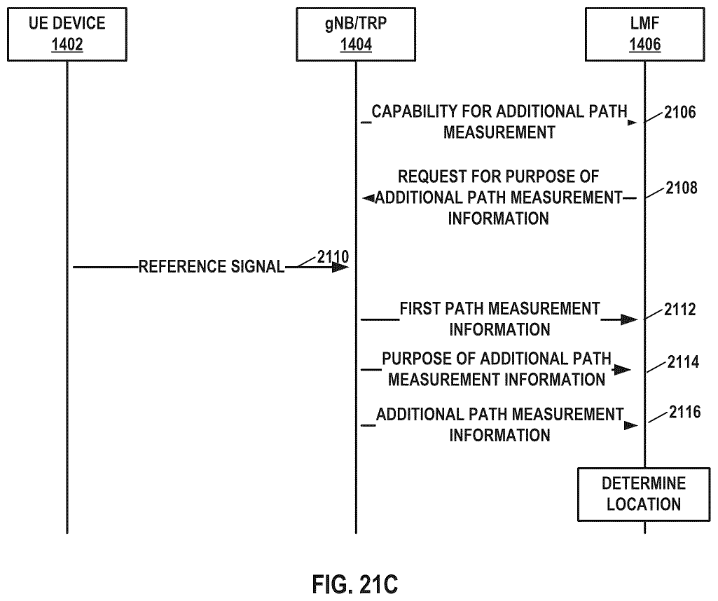

FIGS. 21A-21C are communication diagrams illustrating examples of indicating a purpose of an additional path measurement between a base station and an LMF in accordance with one or more techniques of this disclosure. FIG. 21A is a communication diagram illustrating a first example data exchange between UE device 1402, gNB/TRP device 1404, and LMF device 1406, in accordance with one or more techniques of this disclosure. The data exchange of FIG. 21A is consistent with system 1400D of FIG. 14D. In the example of FIG. 21A, gNB/TRP device 1404 is configured to send an NRPPa Provide Location signaling (e.g., purpose of additional path measurement information 2114) to LMF device 1406. The NRPPa Provide Location signaling indicates the type/purpose of additional path measurement being reported. As one example, NRPPa Provide Location signaling may have one of three integer values. A value of 0 indicates a legacy purpose, a value of 1 indicates a second physical path, and a value of 2 indicates a multi-hypotheses probability distribution of first path or LOS direct path.

In the example of FIG. 21A, gNB/TRP device 1404 may receive reference signal 2110 (e.g., SRS) from UE device 1402 over a first path. gNB/TRP device 1404 may generate first path measurement information 2112 and send first path measurement information 2112 to LMF device 1406. gNB/TRP device 1404 may generate additional path measurement information 2116. Additional path measurement information 2116 may be for a second physical path or multi-hypotheses probability distributions of the first path. gNB/TRP device 1404 may further send purpose of additional path measurement information 2114 (e.g., the NRPPa Provide Location signaling) indicating the purpose of additional path measurement information 2116. LMF device 1406 may determine the location of UE device 1402 based on first path measurement information 2112, purpose of additional path measurement information 2114, and additional path measurement information 2116.

The example of FIG. 21A shows first path measurement information 2112, purpose of additional path measurement information 2114, and additional path measurement information 2116 as separate information elements. In some examples, each of the first path measurement information 2112, purpose of additional path measurement information 2114, and additional path measurement information 2116 may be signaled together in a single data structure. Furthermore, first path measurement information 2112, purpose of additional path measurement information 2114, and additional path measurement information 2116 may be sent in any order.

FIG. 21B is a communication diagram illustrating a first example data exchange between UE device 1402, gNB/TRP device 1404, and LMF device 1406, in accordance with one or more techniques of this disclosure. The data exchange of FIG. 21B is consistent with system 1400D of FIG. 14D. In the example of FIG. 21B, gNB/TRP device 1404 is configured to operate in the same manner as FIG. 21A. However, LMF device 1406 may be configured to send NRPPa Request Location signaling (e.g., request purpose of additional path measurement information 2108) to gNB/TRP device 1404. The NRPPa Request Location signaling request a particular type or purpose of additional paths measurements to be reported by UE device 1402. As a further example, the NRPPa Request Location signaling may further include a request for the type of distribution (e.g., Gaussian, exponential, Rayleigh, etc.) in the case a multi-hypotheses probability distribution purpose is requested.

Furthermore, through the NRPPa request Location signaling, LMF device 1406 can prioritize the type/purpose of additional paths measurement to be obtained and reported by gNB/TRP device 1404. gNB/TRP device 1404 can consider this prioritization when measuring and reporting additional paths measurements (e.g., prioritize multi-hypotheses over physical paths or vice versa).

FIG. 21C is a communication diagram illustrating a first example data exchange between UE device 1402, gNB/TRP device 1404, and LMF device 1406, in accordance with one or more techniques of this disclosure. The data exchange of FIG. 21C is consistent with system 1400D of FIG. 14D. In the example of FIG. 21C, gNB/TRP device 1404 is configured to operate in the same manner as FIG. 21B. However, gNB/TRP device 1404 is further configured to send NRPPa Capability signaling (e.g., capability for additional path measurement 2106) to LMF device 1406 to indicate the type/purpose of additional path measurement being supported by gNB/TRP device 1404. LMF device 1406 may use this information to determine the content for request for purpose of additional path measurement information 2008. The NRPPa Capability signaling may also include the supported probability distributions (e.g., Gaussian, exponential, Rayleigh, etc.) by gNB/TRP device 1404.

Various examples of the techniques of this disclosure are summarized in the following clauses.

Clause 1—A network node configured for wireless communication, the network node comprising: a memory; and one or more processors implemented in circuitry, wherein the one or more processors are communicatively coupled to the memory, and wherein the one or more processors are configured to cause the network node to: send, to a network entity, first path measurement information for a first path; send, to the network entity, additional path measurement information for one or more additional paths; and send, to the network entity, an indication of a purpose of the additional path measurement information, wherein one or more of the first path measurement information or the additional path measurement information is used by the network entity to determine a location of the network node.

Clause 2—The network node of Clause 1, wherein the one or more processors are further configured to cause the network node to: determine one or more of the first path measurement information or the additional path measurement information using an artificial intelligence or machine learning (AI/ML) process.

Clause 3—The network node of any of Clauses 1-2, wherein the purpose of the additional path measurement information is two or more of a legacy purpose, a second path, and a multi-hypotheses distribution of the first path, wherein the second path is different from the first path, and wherein the first path is one of a line-of-sight (LOS) direct path or a non-LOS (NLOS) path.

Clause 4—The network node of Clause 3, wherein the purpose is the multi-hypotheses distribution of the first path, and wherein the additional path measurement information includes one or more of timing information or LOS information, and wherein the timing information and the LOS information include a mean, a variance, and a weight.

Clause 5—The network node of Clause 4, wherein to send, to the network entity, the additional path measurement information for the one or more additional paths, the one or more processors are further configured to cause the network node to: send, to the network entity, the mean of the timing information or the LOS information in a reference signal time of arrival (RTSD) field of downlink time difference of arrive (TDOA) syntax, the variance of the timing information or the LOS information in a timing quality field of the downlink TDOA syntax, and the weight of the timing information or the LOS information in a LOS indicator field with soft representation of the downlink TDOA syntax.

Clause 6—The network node of any of Clauses 1-5, wherein the network node is a user equipment (UE), wherein the network entity executes a location management function (LMF), and wherein to send, to the network entity, the indication of the purpose of the additional path measurement information, the one or more processors are further configured to cause the network node to: send, to the network entity via long term evolution (LTE) positioning protocol (LPP) provide location signaling, the indication of the purpose of the additional path measurement information.

Clause 7—The network node of Clause 6, wherein the one or more processors are further configured to cause the network node to: receive, from the network entity via LPP request location signaling, a request for the purpose of the additional path measurement information.

Clause 8—The network node of Clause 7, wherein the purpose is a multi-hypotheses distribution of the first path, and wherein the one or more processors are further configured to cause the network node to: receive, from the network entity via LPP request location signaling, a second request for a distribution type of the multi-hypotheses distribution of the first path.

Clause 9—The network node of Clause 6, wherein the one or more processors are further configured to cause the network node to: send, to the network entity via LPP capability signaling, capability information indicating one or more of a first capability of the UE to support one or more purposes for the additional path measurement information, or a second capability of the UE to support a distribution type of a multi-hypotheses distribution of the first path.

Clause 10—The network node of any of Clauses 1-5, wherein the network node is a base station, wherein the network entity executes a location management function (LMF), and wherein to send, to the network entity, the indication of the purpose of the additional path measurement information, the one or more processors are further configured to cause the network node to: send, to the network entity via new radio positioning protocol a (NRRPa) provide location signaling, the indication of the purpose of the additional path measurement information.

Clause 11—The network node of Clause 10, wherein the one or more processors are further configured to cause the network node to: receive, from the network entity via NRRPa request location signaling, a request for the purpose of the additional path measurement information.

Clause 12—The network node of Clause 11, wherein the purpose is a multi-hypotheses distribution of the first path, and wherein the one or more processors are further configured to cause the network node to: receive, from the network entity via NRRPa request location signaling, a second request for a distribution type of the multi-hypotheses distribution of the first path.

Clause 13—The network node of Clause 10, wherein the one or more processors are further configured to cause the network node to: send, to the network entity via NRRPa capability signaling, capability information indicating one or more of a first capability of the base station to support one or more purposes for the additional path measurement information, or a second capability of the base station to support a distribution type of a multi-hypotheses distribution of the first path.

Clause 14—A method performed by a network node for wireless communication, the method comprising: sending, to a network entity, first path measurement information for a first path; sending, to the network entity, additional path measurement information for one or more additional paths; and sending, to the network entity, an indication of a purpose of the additional path measurement information, wherein one or more of the first path measurement information or the additional path measurement information is used by the network entity to determine a location of the network node.

Clause 15—The method of Clause 14, further comprising: determining one or more of the first path measurement information or the additional path measurement information using an artificial intelligence or machine learning (AI/ML) process.

Clause 16—A network entity configured for wireless communication, the network entity comprising: a memory; and one or more processors implemented in circuitry, wherein the one or more processors are communicatively coupled to the memory, and wherein the one or more processors are configured to cause the network entity to: receive, from a network node, first path measurement information for a first path; receive, from the network node, additional path measurement information for one or more additional paths; receive, from the network node, an indication of a purpose of the additional path measurement information; and determine a location of the network node based on the first path measurement information, the additional path measurement information, and the purpose of the additional path measurement information.

Clause 17—The network entity of Clause 16, wherein the purpose of the additional path measurement information is two or more of a legacy purpose, a second path, and a multi-hypotheses distribution of the first path, wherein the second path is different from the first path, and wherein the first path is one of a line-of-sight (LOS) direct path or a non-LOS (NLOS) path.

Clause 18—The network entity of Clause 17, wherein the purpose is the multi-hypotheses distribution of the first path, and wherein the additional path measurement information includes one or more of timing information or LOS information, and wherein the timing information and the LOS information include a mean, a variance, and a weight.

Clause 19—The network entity of Clause 18, wherein to receive, from the network node, the additional path measurement information for the one or more additional paths, the one or more processors are further configured to cause the network entity to: receive, from the network node, the mean of the timing information or the LOS information in a reference signal time of arrival (RTSD) field of downlink time difference of arrive (TDOA) syntax, the variance of the timing information or the LOS information in a timing quality field of the downlink TDOA syntax, and the weight of the timing information or the LOS information in a LOS indicator field with soft representation of the downlink TDOA syntax.

Clause 20—The network entity of any of Clauses 16-19, wherein the network node is a user equipment (UE), wherein the network entity executes a location management function (LMF), and wherein to receive, from the network node, the indication of the purpose of the additional path measurement information, the one or more processors are further configured to cause the network entity to: receive, from the network node via long term evolution (LTE) positioning protocol (LPP) provide location signaling, the indication of the purpose of the additional path measurement information.

Clause 21—The network entity of Clause 20, wherein the one or more processors are further configured to cause the network entity to: send, to the network node via LPP request location signaling, a request for the purpose of the additional path measurement information.

Clause 22—The network entity of Clause 21, wherein the purpose is a multi-hypotheses distribution of the first path, and wherein the one or more processors are further configured to cause the network entity to: send, to the network node via LPP request location signaling, a second request for a distribution type of the multi-hypotheses distribution of the first path.

Clause 23—The network entity of Clause 20, wherein the one or more processors are further configured to cause the network entity to: receive, from the network node via LPP capability signaling, capability information indicating one or more of a first capability of the UE to support one or more purposes for the additional path measurement information, or a second capability of the UE to support a distribution type of a multi-hypotheses distribution of the first path.

Clause 24—The network entity of any of Clauses 16-19, wherein the network node is a base station, wherein the network entity executes a location management function (LMF), and wherein to receive, from the network node, the indication of the purpose of the additional path measurement information, the one or more processors are further configured to cause the network entity to: receive, from the network node via new radio positioning protocol a (NRRPa) provide location signaling, the indication of the purpose of the additional path measurement information.

Clause 25—The network entity of Clause 24, wherein the one or more processors are further configured to cause the network entity to: send, to the network node via NRRPa request location signaling, a request for the purpose of the additional path measurement information.

Clause 26—The network entity of Clause 25, wherein the purpose is a multi-hypotheses distribution of the first path, and wherein the one or more processors are further configured to cause the network entity to: send, to the network node via NRRPa request location signaling, a second request for a distribution type of the multi-hypotheses distribution of the first path.

Clause 27—The network entity of Clause 24, wherein the one or more processors are further configured to cause the network entity to: receive, from the network node via NRRPa capability signaling, capability information indicating one or more of a first capability of the base station to support one or more purposes for the additional path measurement information, or a second capability of the base station to support a distribution type of a multi-hypotheses distribution of the first path.

Clause 28—The network entity of any of Clauses 16-27, wherein to determine the location of the network node based on the first path measurement information, the additional path measurement information, and the purpose of the additional path measurement information, the one or more processors are further configured to cause the network entity to: determine the location of the network node using outlier rejection based on the purpose of the additional path measurement information being a second path, wherein the second path is different from the first path, and wherein the first path is one of a line-of-sight (LOS) direct path or a non-LOS (NLOS) path; or determine the location of the network node using likelihood fusion based on the purpose of the additional path measurement information being a multi-hypotheses distribution of the first path, wherein the first path is one of a line-of-sight (LOS) direct path or a non-LOS (NLOS) path.

Clause 29—A method performed by a network entity configured for wireless communication, the method comprising: receiving, from a network node, first path measurement information for a first path; receiving, from the network node, additional path measurement information for one or more additional paths; receiving, from the network node, an indication of a purpose of the additional path measurement information; and determining a location of the network node based on the first path measurement information, the additional path measurement information, and the purpose of the additional path measurement information.

Clause 30—The method of Clause 29, where determining the location of the network node based on the first path measurement information, the additional path measurement information, and the purpose of the additional path measurement information comprises: determining the location of the network node using outlier rejection based on the purpose of the additional path measurement information being a second path, wherein the second path is different from the first path, and wherein the first path is one of a line-of-sight (LOS) direct path or a non-LOS (NLOS) path; or determining the location of the network node using likelihood fusion based on the purpose of the additional path measurement information being a multi-hypotheses distribution of the first path, wherein the first path is one of a line-of-sight (LOS) direct path or a non-LOS (NLOS) path.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A network node configured for wireless communication, the network node comprising:
a memory; and
one or more processors implemented in circuitry, wherein the one or more processors are communicatively coupled to the memory, and wherein the one or more processors are configured to cause the network node to:
send, to a network entity, first path measurement information for a first path;
send, to the network entity, additional path measurement information for one or more additional paths; and
send, to the network entity, an indication of a purpose of the additional path measurement information, wherein one or more of the first path measurement information or the additional path measurement information is used by the network entity to determine a location of the network node.

2. The network node of claim 1, wherein the one or more processors are further configured to cause the network node to:
determine one or more of the first path measurement information or the additional path measurement information using an artificial intelligence or machine learning (AI/ML) process.

3. The network node of claim 1, wherein the purpose of the additional path measurement information is two or more of a legacy purpose, a second path, and a multi-hypotheses distribution of the first path, wherein the second path is different from the first path, and wherein the first path is one of a line-of-sight (LOS) direct path or a non-LOS (NLOS) path.

4. The network node of claim 3, wherein the purpose is the multi-hypotheses distribution of the first path, and wherein the additional path measurement information includes one or more of timing information or LOS information, and wherein the timing information and the LOS information include a mean, a variance, and a weight.

5. The network node of claim 4, wherein to send, to the network entity, the additional path measurement information for the one or more additional paths, the one or more processors are further configured to cause the network node to:
send, to the network entity, the mean of the timing information or the LOS information in a reference signal time of arrival (RTSD) field of downlink time difference of arrive (TDOA) syntax, the variance of the timing information or the LOS information in a timing quality field of the downlink TDOA syntax, and the weight of the timing information or the LOS information in a LOS indicator field with soft representation of the downlink TDOA syntax.

6. The network node of claim 1, wherein the network node is a user equipment (UE), wherein the network entity executes a location management function (LMF), and wherein to send, to the network entity, the indication of the purpose of the additional path measurement information, the one or more processors are further configured to cause the network node to:
send, to the network entity via long term evolution (LTE) positioning protocol (LPP) provide location signaling, the indication of the purpose of the additional path measurement information.

7. The network node of claim 6, wherein the one or more processors are further configured to cause the network node to:
receive, from the network entity via LPP request location signaling, a request for the purpose of the additional path measurement information.

8. The network node of claim 7, wherein the purpose is a multi-hypotheses distribution of the first path, and wherein the one or more processors are further configured to cause the network node to:
receive, from the network entity via LPP request location signaling, a second request for a distribution type of the multi-hypotheses distribution of the first path.

9. The network node of claim 6, wherein the one or more processors are further configured to cause the network node to:
send, to the network entity via LPP capability signaling, capability information indicating one or more of a first capability of the UE to support one or more purposes for the additional path measurement information, or a second capability of the UE to support a distribution type of a multi-hypotheses distribution of the first path.

10. The network node of claim 1, wherein the network node is a base station, wherein the network entity executes a location management function (LMF), and wherein to send, to the network entity, the indication of the purpose of the additional path measurement information, the one or more processors are further configured to cause the network node to:
send, to the network entity via new radio positioning protocol a (NRRPa) provide location signaling, the indication of the purpose of the additional path measurement information.

11. The network node of claim 10, wherein the one or more processors are further configured to cause the network node to:
receive, from the network entity via NRRPa request location signaling, a request for the purpose of the additional path measurement information.

12. The network node of claim 11, wherein the purpose is a multi-hypotheses distribution of the first path, and wherein the one or more processors are further configured to cause the network node to:
receive, from the network entity via NRRPa request location signaling, a second request for a distribution type of the multi-hypotheses distribution of the first path.

13. The network node of claim 10, wherein the one or more processors are further configured to cause the network node to:
send, to the network entity via NRRPa capability signaling, capability information indicating one or more of a first capability of the base station to support one or more purposes for the additional path measurement information, or a second capability of the base station to support a distribution type of a multi-hypotheses distribution of the first path.

14. A method performed by a network node for wireless communication, the method comprising:
sending, to a network entity, first path measurement information for a first path;
sending, to the network entity, additional path measurement information for one or more additional paths; and
sending, to the network entity, an indication of a purpose of the additional path measurement information, wherein one or more of the first path measurement information or the additional path measurement information is used by the network entity to determine a location of the network node.

15. The method of claim 14, further comprising:
determining one or more of the first path measurement information or the additional path measurement information using an artificial intelligence or machine learning (AI/ML) process.

16. A network entity configured for wireless communication, the network entity comprising:
a memory; and
one or more processors implemented in circuitry, wherein the one or more processors are communicatively coupled to the memory, and wherein the one or more processors are configured to cause the network entity to:
receive, from a network node, first path measurement information for a first path;
receive, from the network node, additional path measurement information for one or more additional paths;
receive, from the network node, an indication of a purpose of the additional path measurement information; and
determine a location of the network node based on the first path measurement information, the additional path measurement information, and the purpose of the additional path measurement information.

17. The network entity of claim 16, wherein the purpose of the additional path measurement information is two or more of a legacy purpose, a second path, and a multi-hypotheses distribution of the first path, wherein the second path is different from the first path, and wherein the first path is one of a line-of-sight (LOS) direct path or a non-LOS (NLOS) path.

18. The network entity of claim 17, wherein the purpose is the multi-hypotheses distribution of the first path, and wherein the additional path measurement information includes one or more of timing information or LOS information, and wherein the timing information and the LOS information include a mean, a variance, and a weight.

19. The network entity of claim 18, wherein to receive, from the network node, the additional path measurement information for the one or more additional paths, the one or more processors are further configured to cause the network entity to:
receive, from the network node, the mean of the timing information or the LOS information in a reference signal time of arrival (RTSD) field of downlink time difference of arrive (TDOA) syntax, the variance of the timing information or the LOS information in a timing quality field of the downlink TDOA syntax, and the weight of the timing information or the LOS information in a LOS indicator field with soft representation of the downlink TDOA syntax.

20. The network entity of claim 16, wherein the network node is a user equipment (UE), wherein the network entity executes a location management function (LMF), and wherein to receive, from the network node, the indication of the purpose of the additional path measurement information, the one or more processors are further configured to cause the network entity to:
receive, from the network node via long term evolution (LTE) positioning protocol (LPP) provide location signaling, the indication of the purpose of the additional path measurement information.

21. The network entity of claim 20, wherein the one or more processors are further configured to cause the network entity to:
send, to the network node via LPP request location signaling, a request for the purpose of the additional path measurement information.

22. The network entity of claim 21, wherein the purpose is a multi-hypotheses distribution of the first path, and wherein the one or more processors are further configured to cause the network entity to:
send, to the network node via LPP request location signaling, a second request for a distribution type of the multi-hypotheses distribution of the first path.

23. The network entity of claim 20, wherein the one or more processors are further configured to cause the network entity to:
receive, from the network node via LPP capability signaling, capability information indicating one or more of a first capability of the UE to support one or more purposes for the additional path measurement information, or a second capability of the UE to support a distribution type of a multi-hypotheses distribution of the first path.

24. The network entity of claim 16, wherein the network node is a base station, wherein the network entity executes a location management function (LMF), and wherein to receive, from the network node, the indication of the purpose of the additional path measurement information, the one or more processors are further configured to cause the network entity to:
receive, from the network node via new radio positioning protocol a (NRRPa) provide location signaling, the indication of the purpose of the additional path measurement information.

25. The network entity of claim 24, wherein the one or more processors are further configured to cause the network entity to:
send, to the network node via NRRPa request location signaling, a request for the purpose of the additional path measurement information.

26. The network entity of claim 25, wherein the purpose is a multi-hypotheses distribution of the first path, and wherein the one or more processors are further configured to cause the network entity to:
send, to the network node via NRRPa request location signaling, a second request for a distribution type of the multi-hypotheses distribution of the first path.

27. The network entity of claim 24, wherein the one or more processors are further configured to cause the network entity to:
receive, from the network node via NRRPa capability signaling, capability information indicating one or more of a first capability of the base station to support one or more purposes for the additional path measurement information, or a second capability of the base station to support a distribution type of a multi-hypotheses distribution of the first path.

28. The network entity of claim 16, wherein to determine the location of the network node based on the first path measurement information, the additional path measurement information, and the purpose of the additional path measurement information, the one or more processors are further configured to cause the network entity to:
determine the location of the network node using outlier rejection based on the purpose of the additional path measurement information being a second path, wherein the second path is different from the first path, and wherein the first path is one of a line-of-sight (LOS) direct path or a non-LOS (NLOS) path; or
determine the location of the network node using likelihood fusion based on the purpose of the additional path measurement information being a multi-hypotheses distribution of the first path, wherein the first path is one of a line-of-sight (LOS) direct path or a non-LOS (NLOS) path.

29. A method performed by a network entity configured for wireless communication, the method comprising:
receiving, from a network node, first path measurement information for a first path;
receiving, from the network node, additional path measurement information for one or more additional paths;
receiving, from the network node, an indication of a purpose of the additional path measurement information; and
determining a location of the network node based on the first path measurement information, the additional path measurement information, and the purpose of the additional path measurement information.

30. The method of claim 29, where determining the location of the network node based on the first path measurement information, the additional path measurement information, and the purpose of the additional path measurement information comprises:
determining the location of the network node using outlier rejection based on the purpose of the additional path measurement information being a second path, wherein the second path is different from the first path, and wherein the first path is one of a line-of-sight (LOS) direct path or a non-LOS (NLOS) path; or
determining the location of the network node using likelihood fusion based on the purpose of the additional path measurement information being a multi-hypotheses distribution of the first path, wherein the first path is one of a line-of-sight (LOS) direct path or a non-LOS (NLOS) path.
